(19) United States
(12) Patent Application Publication
(10) Pub. No.: US 2026/0030831 A1
(43) Pub. Date: Jan. 29, 2026

(54) GRAPHICS PROCESSING

(71) Applicant: Arm Limited, Cambridge (GB)

(72) Inventors: Marius Bjørge, Cambridge (GB); Yoav Asher Levy, Cambridge (GB)

(73) Assignee: Arm Limited, Cambridge (GB)

(21) Appl. No.: 19/278,176

(22) Filed: Jul. 23, 2025

(30) Foreign Application Priority Data
Jul. 29, 2024 (GB) 2411090.0

(51) Int. Cl. G06T 15/06; G06T 15/00

(52) U.S. Cl. CPC G06T 15/06; G06T 15/005; G06T 2210/21

(57) ABSTRACT

A graphics processing system that is operable to perform ray tracing using micromaps is disclosed. First information representative of a micromap is used to determine whether further information should be fetched and used to determine a property value defined by the micromap. The first information may represent a coarse representation of the micromap, and the further information may represent a finer representation of the primitive.

### BACKGROUND

The technology described herein relates to graphics processing systems, and in particular to the rendering of frames (images) for display using ray tracing.

FIG. 1 shows an exemplary system on-chip (SoC) graphics processing system 8 that comprises a host processor in the form of a central processing unit (CPU) 1, a graphics processor (GPU) 2, a display processor 3 and a memory controller 5.

As shown in FIG. 1, these units communicate via an interconnect 4 and have access to off-chip memory 6. In this system, the graphics processor 2 will render frames (images) to be displayed, and the display processor 3 will then provide the frames to a display panel 7 for display.

In use of this system, an application 13 such as a game, executing on the host processor (CPU) 1 will, for example, require the display of frames on the display panel 7. To do this, the application will submit appropriate commands and data to a driver 11 for the graphics processor 2 that is executing on the CPU 1. The driver 11 will then generate appropriate commands and data to cause the graphics processor 2 to render appropriate frames for display and to store those frames in appropriate frame buffers, e.g. in the main memory 6. The display processor 3 will then read those frames into a buffer for the display from where they are then read out and displayed on the display panel 7 of the display.

One rendering process that may be performed by a graphics processor is so-called “ray tracing”. Ray tracing is a rendering process which involves tracing the paths of rays of light from a viewpoint (sometimes referred to as a “camera”) back through sampling positions in an image plane into a scene, and simulating the effect of the interaction between the rays and objects in the scene. The output data value for a sampling position in the image (plane) is determined based on the object(s) in the scene intersected by the ray passing through the sampling position, and the properties of the surfaces of those objects. The ray tracing calculation is complex, and involves determining, for each sampling position, a set of zero or more objects within the scene which a ray passing through the sampling position intersects.

FIG. 2 illustrates an exemplary “full” ray tracing process. A ray 20 (the “primary ray”) is cast backward from a viewpoint 21 (e.g. camera position) through a sampling position 22 in an image plane (frame) 23 into the scene that is being rendered. The point 24 at which the ray 20 first intersects an object in the scene is identified. This first intersection will be with the object in the scene closest to the sampling position. In this example, the first intersected object is represented by a set (e.g. mesh) of triangle primitives, and the ray 20 is found to intersect a triangle primitive 25 representing the object. A secondary ray in the form of shadow ray 26 may be cast from the first intersection point 24 to a light source 27. Depending upon the material of the surface of the object, another secondary ray in the form of reflected ray 28 may be traced from the intersection point 24. If the object is, at least to some degree, transparent, then a refracted secondary ray may be considered.

Ray tracing is considered to provide better, e.g. more realistic, physically accurate images than more traditional rasterisation rendering techniques, particularly in terms of the ability to capture reflection, refraction, shadows and lighting effects. However, ray tracing can be significantly more processing-intensive than traditional rasterisation, and so it is usually desirable to be able to accelerate ray tracing.

One way of accelerating ray tracing is the use of so-called “micromaps”. In such techniques, a primitive is sub-divided into a “micromesh” comprising equally sized and shaped “sub-primitives”, and a property (e.g. opacity) value is stored for each such sub-primitive. The use of micromaps allows fine detail to be more efficiently encoded and processed, e.g. as compared to more traditional texture-based approaches.

The inventors believe that there remains scope for improved techniques for performing ray tracing using a graphics processor.

### BRIEF DESCRIPTION OF THE DRAWINGS

Embodiments of the technology described herein will now be described by way of example only and with reference to the accompanying drawings, in which:

FIG. 1 shows an exemplary graphics processing system;

FIG. 2 is a schematic diagram illustrating a “full” ray tracing process;

FIG. 3A and FIG. 3B show exemplary ray tracing acceleration data structures;

FIG. 4A and FIG. 4B are flow charts illustrating embodiments of a full ray tracing process;

FIG. 5 is a schematic diagram illustrating a “hybrid” ray tracing process;

FIG. 6 shows schematically an embodiment of a graphics processor that can be operated in the manner of the technology described herein;

FIG. 7 shows schematically the ray tracing unit of the graphics processor of FIG. 6 in more detail;

FIG. 8A, FIG. 8B and FIG. 8C illustrate micromap sub-division and indexing;

FIG. 9 illustrates an exemplary opacity micromap;

FIG. 10 illustrates a first data structure for storing micromap data in accordance with embodiments;

FIG. 11 illustrates a second data structure for storing finer grained micromap data in accordance with embodiments;

FIG. 12 illustrates an efficient encoding of the opacity micromap of FIG. 9;

FIG. 13 is a flow chart illustrating a process for storing a micromap in accordance with embodiments; and

FIG. 14 is a flow chart illustrating a process for determining an opacity value in accordance with embodiments.

### DETAILED DESCRIPTION

A first embodiment of the technology described herein comprises a method of operating a graphics processing system that is operable to render a scene represented by primitives by tracing rays through the scene and controlling interactions between rays and sub-regions of primitives using property values defined by one or more micromaps; the method comprising:
providing a micromap that defines property values for a set of sub-regions of a primitive;
generating and storing information representative of the micromap;
using the information to determine a property value defined by the micromap for a sub-region of the set of sub-regions of the primitive; and
using the determined property value to control an interaction between a ray and the sub-region of the primitive;
wherein:
the information comprises first information that can be used to determine whether further information should be used to determine a property value defined by the micromap; and
using the information to determine a property value defined by the micromap for a sub-region of the set of sub-regions of the primitive comprises:
   (fetching the first information;)
   using the (fetched) first information to determine whether further information should be used to determine the property value for the sub-region; and
   when it is determined that further information should be used to determine the property value for the sub-region:
      fetching further information; and
      using the (fetched) further information to determine the property value for the sub-region.

A second embodiment of the technology described herein comprises a graphics processing system that is operable to render a scene represented by primitives by tracing rays through the scene and controlling interactions between rays and sub-regions of primitives using property values defined by one or more micromaps; the system comprising:
a generating circuit configured to generate and store information representative of a micromap, wherein the micromap defines property values for a set of sub-regions of a primitive; and
a processing circuit configured to:
   use information generated and stored by the generating circuit to determine a property value defined by a micromap for a sub-region of a set of sub-regions of a primitive; and
   use the determined property value to control an interaction between a ray and the sub-region of the primitive;
wherein:
the generating circuit is configured to generate and store information representative of a micromap that comprises first information that can be used by the processing circuit to determine whether further information should be used to determine a property value defined by the micromap; and
the processing circuit is configured to use information generated and stored by the generating circuit to determine a property value defined by a micromap for a sub-region of a set of sub-regions of a primitive by:
   (fetching first information;)
   using (the fetched) first information to determine whether further information should be used to determine the property value for the sub-region; and
   when it is determined that further information should be used to determine the property value for the sub-region:
      fetching further information; and
      using the (fetched) further information to determine the property value for the sub-region.

The technology described herein relates to a graphics processing system in which property values for sub-regions of primitives can be defined by micromaps. As discussed above, and in embodiments, a micromap effectively sub-divides a primitive into a set of plural equally sized and shaped sub-regions (“sub-primitives”), and defines a property value for each such sub-region.

In the technology described herein, information representative of a micromap is generated and stored, and fetched (loaded) and used to determine a property value defined by the micromap for a sub-region of a primitive. The determined property value is used to control an interaction between a ray and the sub-region of the primitive. For example, the determined property value may be, and in embodiments is, used during ray tracing to determine whether and/or how a ray interacts with the sub-region of the primitive. For example, and in embodiments, an opacity value defined by an opacity micromap is used to determine whether or not a sub-region of a primitive is opaque, and thus whether or not a ray should e.g. pass through the primitive sub-region.

In the technology described herein, the information representative of the micromap includes (at least) first information that can be, and in embodiments is, fetched/loaded (e.g. independently) and used to determine whether further information needs to be (fetched/loaded and) used in order to determine a property value defined by the micromap for a sub-region.

As will be discussed in more detail below, the first information may represent a relatively coarse, and thus less resource intensive, representation of the micromap, whereas the further information may represent a relatively finer grained, and thus more resource intensive, representation of the micromap. In embodiments, the further (e.g. finer grained/resource intensive) information is only fetched/loaded and used when it is determined from the first (e.g. coarser grained/less resource intensive) information that the further information should be fetched/loaded and used.

The first (e.g. coarser grained/less resource intensive) information may thus act as a “filter” by means of which fetching of the further (e.g. finer grained/resource intensive) information can be limited to only those situations where that is necessary. The inventors have found that this can facilitate an overall reduction in memory, bandwidth and processing requirements.

It will be appreciated, therefore, that the technology described herein can provide an improved graphics processing system and ray tracing method.

The graphics processing system should, and in embodiments does, comprise a graphics processor (GPU). The graphics processing system may further comprise a host processor, e.g. a central processing unit (CPU). The host processor (e.g. CPU) may execute applications that can require graphics processing by the graphics processor (GPU), and send appropriate commands and data to the graphics processor (GPU) to control it to perform graphics processing operations and to produce graphics processing (render) output required by applications executing on the host processor (CPU).

To facilitate this, the host processor (CPU) in embodiments also executes a driver for the graphics processor (GPU). Thus, in embodiments, the graphics processing system comprises a graphics processor (GPU) that is in communication with a host microprocessor (CPU) that executes a driver for the graphics processor (GPU).

A (each) operation of the technology described herein may be performed by the graphics processor (GPU), and/or host processor (CPU), and/or another component of the graphics processing system, as appropriate. Correspondingly, a (each) circuit of the technology described herein may form part of the graphics processor (GPU), and/or host processor (CPU), and/or another component of the graphics processing system, as appropriate.

For example, a micromap may be provided in any suitable and desired manner. In embodiments, a micromap is provided (e.g. defined) by an application, e.g. executing on the host processor (CPU). In embodiments, a micromap (defined by an application) is provided to the graphics processor (GPU), e.g. by the driver executing on the host processor (CPU).

Similarly, information representing micromap may be generated by the graphics processor (GPU) processing a micromap (that has been provided to it). Alternatively, information representing a micromap may be generated by (e.g. an application or the driver executing on) the host processor (CPU) or another data processor of a data processing system (and the generated information then provided to the graphics processor (GPU)). Thus, the generating circuit may be part of the graphics processor (GPU) and/or host processor (CPU), e.g. the driver, and/or another data processor.

In embodiments, (at least) fetching and use of micromap information is performed by a (the) graphics processor (GPU). Thus, in embodiments, (at least) the processing circuit is part of a (the) graphics processor (GPU).

Thus, another embodiment of the technology described herein comprises a method of operating a graphics processor that is operable to render a scene represented by primitives by tracing rays through the scene and controlling interactions between rays and sub-regions of primitives using property values defined by one or more micromaps; the method comprising:
using information representative of a micromap to determine a property value defined by the micromap for a sub-region of a set of sub-regions of a primitive; and
using the determined property value to control an interaction between a ray and the sub-region of the primitive;
wherein:
the information comprises first information that can be used to determine whether further information should be used to determine a property value defined by the micromap; and
using the information to determine a property value defined by the micromap for a sub-region of the set of sub-regions of the primitive comprises:
   (fetching the first information;)
   using the (fetched) first information to determine whether further information should be used to determine the property value for the sub-region; and
   when it is determined that further information should be used to determine the property value for the sub-region:
      fetching further information; and
      using the (fetched) further information to determine the
   property value for the sub-region.

Another embodiment of the technology described herein comprises a graphics processor that is operable to render a scene represented by primitives by tracing rays through the scene and controlling interactions between rays and sub-regions of primitives using property values defined by one or more micromaps; the processor comprising:
a fetching circuit configured to fetch information representative of a micromap, wherein the micromap defines property values for a set of sub-regions of a primitive; and
a processing circuit configured to:
   use information fetched by the fetching circuit to determine a property value defined by a micromap for a sub-region of a set of sub-regions of a primitive; and
   use the determined property value to control an interaction between a ray and the sub-region of the primitive;
wherein the processing circuit is configured to use information fetched by the fetching circuit to determine a property value defined by a micromap for a sub-region of a set of sub-regions of a primitive by:
   using first information (fetched by the fetching circuit) to determine whether further information should be used to determine the property value for the sub-region; and
   when it is determined that further information should be used to determine the property value for the sub-region:
      causing the fetching circuit to fetch further information; and
      using the (fetched) further information to determine the property value for the sub-region.

The fetching circuit and the processing circuit may comprise separate circuits, or may be at least partially formed of shared processing circuits.

These embodiments can, and in embodiments do, include any one or more or all of the optional features described herein, as appropriate. For example, the graphics processor may (comprise a (the) generating circuit configured to) generate the information representing the micromap.

In embodiments of the technology described herein, the graphics processing system/processor is operable to perform ray tracing, e.g. and in embodiments, in order to generate a render output, such as a frame for display, e.g. that represents a view of a scene comprising one or more objects. The graphics processing system/processor may typically generate plural render outputs, e.g. a series of frames.

A render output will typically comprise an array of data elements (sampling points) (e.g. pixels), for each of which appropriate render output data (e.g. a set of colour value data) is generated by the graphics processing system/processor. A render output data may comprise colour data, for example, a set of red, green and blue, RGB values and a transparency (alpha, a) value.

The graphics processing system/processor may carry out ray tracing graphics processing operations in any suitable and desired manner. The graphics processing system/processor may comprise one or more programmable execution units (e.g. shader cores) operable to execute programs to perform graphics processing operations, and ray-tracing based rendering may be triggered and performed by a programmable execution unit of the graphics processing system/processor executing a graphics processing (e.g. shader) program that causes the programmable execution unit to perform ray tracing rendering processes.

In embodiments, the graphics processing system/processor (comprises a ray tracing circuit that) is operable to perform ray tracing by traversing a ray tracing acceleration data structure. The ray tracing acceleration data structure may comprise a tree structure that refers to, or incorporates, information representing a micromap as described herein. Thus, in embodiments, information representing a micromap is part of a ray tracing acceleration data structure.

A (the) ray tracing acceleration data structure may be generated by the same graphics processor that then traverses the ray tracing acceleration data structure. Alternatively, a (the) ray tracing acceleration data structure may be generated by a different data processor to the graphics processor that traverses the ray tracing acceleration data structure. For example, a ray tracing acceleration data structure may be generated the host processor, e.g. CPU, or another processor, of a data processing system. Generation of information representative of a micromap may be performed as part of, or separately to, generation of the ray tracing acceleration data structure.

In embodiments, the ray tracing acceleration data structure comprises a plurality of nodes, with each node of the ray tracing acceleration data structure representing a respective volume of a scene to be rendered, and at least some of the nodes being associated with one or more primitives that fall within the respective volume (and for which a micromap may define property values). In embodiments, the ray tracing acceleration data structure is arranged as a hierarchy of nodes representing a hierarchy of volumes, e.g. and in embodiments, the ray tracing acceleration data structure comprises one or more bounding volume hierarchies (BVHs). In embodiments, the ray tracing acceleration data structure comprises end (e.g. leaf) nodes that are each associated with (represent) a set of one or more primitives defined within the respective volume that the end (e.g. leaf) node corresponds to.

In embodiments, the graphics processing system/processor (comprises a ray-volume intersection testing circuit that) is operable to test rays for intersection with volumes that are represented by the nodes of the ray tracing acceleration data structure (e.g. BVH). When a ray is found to intersect a node that is associated with one or more primitives, e.g. when a ray is found to intersect an end (e.g. leaf) node, the ray is tested for intersection with the one or more primitives that the (e.g. end/leaf) node corresponds to (by a ray-primitive intersection testing circuit of the graphics processor).

In embodiments, when a ray is found (by the ray-primitive intersection testing circuit) to intersect a primitive that is associated with a micromap, a property (value) for a region of the primitive that the ray intersects is determined using information representative of the micromap, and used to determine whether and/or how the ray interacts with the primitive.

Thus, in embodiments, (fetching and) using the information representative of a micromap is performed in response to determining that a (the) ray intersects a (the) primitive that the micromap defines properties (property values) for, and/or in response to determining that a (the) ray intersects a ray tracing acceleration data structure (e.g. BVH) volume that a (the) primitive falls within.

Thus, in embodiments, the graphics processing system/processor is operable to trace a ray by traversing a ray tracing acceleration data structure and testing the ray against volumes represented by nodes of the ray tracing acceleration data structure to determine whether the ray intersects the volumes, and when it is determined that the ray intersects a volume represented by a node of the ray tracing acceleration data structure that is associated with one or more primitives that fall within the volume that the node represents, testing the ray against the one or more primitives to determine whether the ray intersects the one or more primitives, and when it is determined that the ray intersects a primitive of the one or more primitives that is associated with information representative of a micromap, use the information to determine a property (value) for a sub-region of the primitive that the ray intersects.

A primitive which a micromap defines sub-region properties (property values) for may be any suitable (graphics) primitive, e.g. a polygon. Similarly, a (each) primitive sub-region that a micromap defines a property value for may be any suitable (e.g. two-dimensional) sub-region (sub-primitive) of a primitive that represents some but not all of the primitive (area).

The primitive sub-regions that a primitive is divided into (and which a micromap defines property values for) should be, and in embodiments are, all the same size and shape. In embodiments, the primitive sub-regions have the same shape as (but a smaller size than) the sub-divided primitive. Correspondingly, in embodiments, a primitive which a micromap defines sub-region property values for should be, and in embodiments is, a primitive that can be (recursively) sub-divided into sub-regions that have the same size and shape, and that in embodiments have the same shape as (but a smaller size than) the primitive. Thus, in embodiments, a primitive which a micromap defines sub-region property values for has a self-similar shape.

In embodiments, a primitive which a micromap defines sub-region property values for is a triangle primitive. Thus, in embodiments, a micromap defines a respective property value for each sub-triangle of plural (equal size and shape) sub-triangles of a triangle primitive. Other (e.g. self-similar) primitive shapes, such as a rectangle, may be possible.

The number of primitive sub-regions (e.g. sub-triangles) that a micromap defines property values for can be any suitable number. Primitive sub-regions could be defined by sub-dividing a primitive into a power of 2 number of sub-regions, for example. In embodiments, primitive sub-regions are defined by a “four-way” recursive sub-division of a primitive into sub-regions. Thus, in embodiments, a (e.g. triangle) primitive is sub-divided into 2²ⁿ sub-regions (e.g. sub-triangles), where n is a positive integer. For example, and in embodiments, a triangle primitive is sub-divided into 4, 16, 64, or 256 etc., (equally sized and shaped) sub-triangles, and a micromap defines a respective property value for each such sub-triangle.

A micromap may define property values for only one primitive, or for plural different primitives, e.g. in the (same) scene. Similarly, a primitive may have a micromap associated with it, or no micromap associated with it.

The property that a micromap defines values for can be any suitable property whose values can be used to determine an interaction between a ray and a primitive sub-region, e.g. a scalar, colour, normal, or other rendering property. In embodiments, a (each) micromap is an opacity micromap that defines opacity (e.g. “alpha”) values for sub-regions of a primitive.

An opacity value can be any suitable value indicating opacity of a primitive sub-region. An opacity value could indicate a degree of opacity. In embodiments, an opacity value indicates whether or not a primitive sub-region is opaque (or whether or not a primitive sub-region is transparent).

In embodiments, an opacity value is (e.g. a one-bit value that is) one of (only) two possible values: a first value indicating that a primitive sub-region is not opaque (e.g. is transparent), and a second value indicating that a primitive sub-region is opaque (e.g. is not transparent). In other embodiments, an opacity value is (e.g. a two-bit value that is) one of (only) four possible values: e.g. a first value indicating that a primitive sub-region is (fully) transparent, a second value indicating that a primitive sub-region is (fully) opaque, a third value indicating unknown or partial transparency, and a fourth value indicating unknown or partial opacity. Other arrangements are possible.

In the technology described herein, information representative of a micromap that comprises first information and (possibly) further information is generated and stored (by the generating circuit), and used (during ray tracing) (by the processing circuit) to determine a property value(s) defined by the micromap. The first information may be fetched (independently of the further information) and used to determine whether the further information should be (fetched and) used to determine the property value. When it is determined that further information should be (fetched and) used, it is fetched and used. In embodiments, when it is not determined that further information should be (fetched and) used (when it is determined that further information should not be (fetched and) used), it is not fetched or used, and e.g. (only) the first information is used to determine the property value.

In embodiments, the first information represents a coarse representation of the micromap, and the further information represents a finer representation of (at least some of) the micromap. For example, and in embodiments, the first information represents a lower fidelity/resolution representation of the micromap, and the further information represents a higher fidelity/resolution representation of (at least some of) the micromap. In embodiments, a coarse representation of a micromap can be stored using less memory space than a finer representation of the micromap.

In embodiments, further information representing a finer representation of a micromap is (only) fetched and used to determine a property value defined by the micromap when the property value cannot be (conclusively) determined using first information that represents a coarser representation of the micromap.

The (first and/or further) information representative of a micromap can be stored (by the generating circuit) in any suitable manner. The information may be stored in storage that is local to (e.g. on the same chip as) the graphics processor, and/or in storage that is external (e.g. on a different chip) to the graphics processor. In embodiments, the information is stored in (and fetched/loaded from) a (e.g. main) memory of a graphics processing system that the graphics processor is part of. Thus, embodiments of the technology described herein relate to a graphics processing system that comprises the graphics processor and a memory. In embodiments, the graphics processor comprises a cache system via which it can communicate with the memory, and via which information representative of a micromap may be fetched/loaded.

In embodiments, e.g. to facilitate efficient memory access, one or more predefined data structures are used to store and fetch/load the information representative of a micromap. Thus, in embodiments, storing information representative of a micromap comprises storing the information (in the memory) in one or more predefined data structures. In embodiments, fetching information representative of a micromap comprises fetching/loading the information (from the memory) from one or more predefined data structures.

In embodiments, a predefined data structure has a particular, in embodiments selected, in embodiments predetermined, in embodiments fixed, size. In embodiments, a predefined data structure has a (fixed) size that is equal to an integer number of cache entries (e.g. cache lines) of the cache system. That is, in embodiments, a predefined data structure is cache aligned. For example, in the case of 64-byte cache entries, a predefined data structure may be 64-bytes, 128-bytes, etc., in size.

In embodiments, a predefined data structure has a particular, in embodiments selected, in embodiments predetermined, in embodiments fixed, data layout. A predefined data structure may, for example and in embodiments, comprise particular fields that can e.g. each store information indicative of a micromap property value. A predefined data structure may (further) comprise fields that can store other data.

In embodiments, a first predefined data structure is used to store and fetch (load) (at least) the first (e.g. coarse) information, and a second, different predefined data structure is used to store and fetch (load) (at least) the further (e.g. finer) information. The first and second data structures may have the same or different sizes. The first and second data structures may have the same or different data layouts.

In embodiments, a first predefined data structure comprises one or more fields for storing micromap property value data. In embodiments, a first predefined data structure is used to store and fetch first (e.g. coarse) information representative of a micromap and data (e.g. vertex data) defining a corresponding primitive. A first predefined data structure may accordingly further comprise one or more fields for storing data (e.g. vertex data) defining a corresponding primitive. In embodiments, a first predefined data structure further comprises one or more fields for storing one or more links (e.g. pointers) to one or more second predefined data structures that store further (e.g. finer) information for the (same) micromap.

In embodiments, a second predefined data structure is used to store and fetch (load) only further (e.g. finer) information representative of a micromap. A second predefined data structure may accordingly (only) comprise one or more fields for storing micromap property value data. Other arrangements are possible.

In embodiments, a first predefined data structure is fetched (by the processing/fetching circuit), data defining a primitive stored in the fetched data structure is used to test a ray for intersection with the primitive, and when it is determined that they ray intersects the primitive, first information representative of a micromap stored in the fetched data structure is used to determine a property value defined by the micromap. In embodiments, the first information stored in the fetched data structure is used to determine whether further information should be (fetched and) used to determine the property value, and when it is determined that further information should be (fetched and) used, one or more second predefined data structures are fetched (by the fetching circuit) (e.g. by following a link (e.g. pointer) in the first predefined data structure), and further information representative of the micromap stored in the one or more second predefined data structures is used to determine the property value defined by the micromap.

The first information could be representative of a coarse representation of a micromap in any/all circumstances. However, in embodiments, where it is possible to directly represent a micromap in a (fixed size) first predetermined data structure, that is done so. Thus, the first information (stored in a first predetermined data structure) may represent a coarse representation of the micromap, or may directly represent (individual property values defined by) the micromap.

In embodiments, a direct representation is used where the size (e.g. number of sub-regions) of the micromap is less than (or equal to) a threshold value, and a coarse representation is used where the size (e.g. number of sub-regions) of the micromap is greater than the threshold value. The threshold may be a fixed threshold, or determined dynamically. The threshold may correspond to a maximum amount of storage available in a (fixed size) first predetermined data structure.

Thus, in embodiments, generating and storing the information representative of the micromap (by the generating circuit) comprises: determining whether a size of the micromap is greater than a threshold (and e.g. is thus too large to be stored (directly) in a (fixed size) first predetermined data structure). In embodiments, when it is determined that a size of the micromap is greater than the threshold: a coarse representation of the micromap is generated, and information representing the coarse representation of the micromap is stored as the first information (in a first predefined data structure). In embodiments, when it is not determined that a size of the micromap is greater than the threshold (when it is determined that a size of the micromap is less than or equal to the threshold): information directly representing the micromap is stored as the first information (in a first predefined data structure).

A size of the micromap may be indicated by the number of sub-regions of the set of sub-regions. In embodiments where primitive sub-regions are defined by a recursive sub-division operation, a size of the micromap may be indicated by the level of recursive sub-division (e.g. n). Thus, in embodiments, determining whether a size of the micromap is greater than a threshold comprises determining whether a micromap sub-division level for the micromap is greater than a threshold level. The threshold level may, for example, be n=2, 3, 4, 5 or another level.

A coarse representation of a micromap can be generated (by the generating circuit) in any suitable manner. In embodiments, a coarse representation of the micromap is generated by grouping sub-regions of the set of sub-regions of the primitive into larger sub-regions, and storing e.g. a single data value to represent each such group/larger sub-region. In embodiments, the e.g. single data value stored for each group/larger sub-region indicates (at least) whether the micromap defines the same or different property values for sub-regions of the set of sub-regions that are encompassed by the respective larger sub-region.

Thus, in embodiments, generating a coarse representation of the micromap comprises, for (each of) one or more larger sub-regions of the primitive: determining whether the micromap defines the same or different property values for sub-regions of the set of sub-regions that are encompassed by the respective larger sub-region; and generating (and storing) an indication of whether the micromap defines different property values for sub-regions of the set of sub-regions that are encompassed by the respective larger sub-region or whether the micromap defines the same property value for sub-regions of the set of sub-regions that are encompassed by the respective larger sub-region (and an indication of that property value).

In the case of an opacity micromap, in embodiments, a (each) indication/value for a larger sub-region of a coarse representation of the micromap may be: a first value indicating that all sub-regions encompassed by the larger sub-region are (fully) transparent, a second value indicating that all sub-regions encompassed by the larger sub-region are (fully) opaque, or a third value indicating that further information should be (fetched and) used to determine a property value for sub-regions encompassed by the larger sub-region. Other arrangements are possible.

A larger sub-region can be any region of the primitive that encompasses plural sub-regions of the set of sub-regions for which the micromap defines property values. In embodiments, the larger sub-regions are non-overlapping regions that each encompass a respective contiguous subset of the set of sub-regions.

In embodiments where primitive sub-regions are defined by a recursive sub-division operation, a (each) larger sub-region may correspond to a lower level sub-division operation. In embodiments, a (each) larger sub-region corresponds to a threshold level sub-region. Thus, in embodiments, when a micromap sub-division level for the micromap is greater than a threshold level (e.g. n=2, 3, 4, 5 or another level), a coarse representation of the micromap is generated and stored (as the first information), wherein the coarse representation of the micromap comprises an indication (e.g. value) for each threshold level sub-region of the primitive.

In the case of a coarse representation of the micromap being generated and stored (by the generating circuit), further information representative of a finer representation of the micrmap may represent the entirety of the micromap. In embodiments, further information representative of a finer representation of the micromap is only generated and stored (by the generating circuit) for those regions of the micromap where that is necessary (e.g. for those regions where the coarse information does not (conclusively) define a micromap property value/where the coarse information indicates further information should be used). This can save storage requirements.

In embodiments, when it is determined that the micromap defines different property values for sub-regions of the set of sub-regions that are encompassed by a larger (e.g. threshold-level) sub-region: information representing the different property values is generated and stored (by the generating circuit) as further information. In embodiments, the further information is stored in one or more second predefined data structures, and one or more links (e.g. pointers) to the one or more second predefined data structures are stored in the corresponding first predefined data structure (with the first information).

Another embodiment of the technology described herein comprises a method of storing information representative of a micromap for use by a graphics processor that is operable to render a scene represented by primitives by tracing rays through the scene and controlling interactions between rays and sub-regions of primitives using property values defined by one or more micromaps; the method comprising:
providing a micromap that defines property values for a set of sub-regions of a primitive; and
generating and storing information representative of the micromap by: for (each of) one or more larger sub-regions of the primitive:
   determining whether the micromap defines the same or different property values for sub-regions of the set of sub-regions that are encompassed by the respective larger sub-region; and
   generating and storing first information indicating whether the micromap defines the same or different property values for sub-regions of the set of sub-regions that are encompassed by the respective larger sub-region; and
   when it is determined that the micromap defines different property values for sub-regions of the set of sub-regions that are encompassed by the respective larger sub-region:
      generating and storing further information representing the different property values.

Another embodiment of the technology described herein comprises an apparatus operable to store information representative of a micromap for use by a graphics processor that is operable to render a scene represented by primitives by tracing rays through the scene and controlling interactions between rays and sub-regions of primitives using property values defined by one or more micromaps; the apparatus comprising:
a generating circuit configured to generate and store information representative of a micromap that defines property values for a set of sub-regions of a primitive by:
for (each of) one or more larger sub-regions of the primitive:
   determining whether the micromap defines the same or different property values for sub-regions of the set of sub-regions that are encompassed by the respective larger sub-region; and
   generating and storing first information indicating whether the micromap defines the same or different property values for sub-regions of the set of sub-regions that are encompassed by the respective larger sub-region; and
   when it is determined that the micromap defines different property values for sub-regions of the set of sub-regions that are encompassed by the respective larger sub-region:
      generating and storing further information representing the different property values.

These embodiments can, and in embodiments do, include any one or more or all of the optional features described herein, as appropriate. For example, the generating circuit may generate and store first information that directly represents a micromap when the micromap is smaller than a threshold, e.g. as described above.

In embodiments, when it is not determined that the micromap defines different property values for sub-regions of the set of sub-regions that are encompassed by a larger (e.g. threshold-level) sub-region (when it is determined that the micromap defines the same property value for sub-regions of the set of sub-regions that are encompassed by a larger (e.g. threshold-level) sub-region): further information is not generated and stored (for that larger sub-region).

The first information can indicate whether further information should be used to determine a property value in any suitable manner. In embodiments, where the first information directly represents the micromap, that is taken (by the processing circuit) as an indication that further information should not be used to determine a property value, but that the property value should be determined directly from the first information.

Thus, in embodiments, it is determined (by the processing circuit) whether the first information directly represents the micromap; and when it is determined that the first information directly represents the micromap: it is determined that further information should not be used to determine the property value for the sub-region. In this case, in embodiments, the first information alone is used (by the processing circuit) to determine the property value, e.g. by using the appropriate property value directly indicated by the first information.

Where the first information represents a coarse representation of the micromap, the coarse information indicating the same property value is taken (by the processing circuit) as an indication that further information should not be used to determine a property value, but that the property value should be determined directly from the first information. In embodiments, the coarse information indicating different property values is taken (by the processing circuit) as an indication that further information should be (fetched and) used to determine a property value.

Thus, in embodiments, it is determined (by the processing circuit) whether the coarse representation of the micromap indicates different property values for a larger (e.g. threshold-level) sub-region that encompasses the sub-region. In embodiments, when it is determined that the coarse representation of the micromap indicates different property values for a larger sub-region that encompasses the sub-region: it is determined that further information should be used to determine the property value for the sub-region. In this case, in embodiments, the further information is fetched and used to determine the property value.

In embodiments, when it is not determined that the coarse representation of the micromap indicates different property values for a larger sub-region that encompasses the sub-region (when it is determined that the coarse representation of the micromap indicates the same property value for a larger sub-region that encompasses the sub-region): it is determined that further information should not be used to determine the property value for the sub-region. In this case, in embodiments, the first information alone is used to determine the property value, e.g. by using the same property value indicated by the first information.

The further information (stored in a second predetermined data structure) represents a finer representation of the micromap than the first information. For example, the further information may directly represent (individual property values defined by) the micromap. Alternatively, the further information may represent a coarse representation of the micromap (that is finer than the first information). In this case, in embodiments, the further information may be used to determine whether further, even finer information should be used to determine a property value defined by the micromap, etc. Thus, there may be one or more “filter levels” by means of which fetching of finer information can be limited to only those situations where that is necessary.

Once a property value for a sub-region has been determined, it is used to control an interaction between a ray and the sub-region. In embodiments, a determined property value is used to determine a ray-primitive interaction. For example, and in embodiments, in the case of an opacity micromap, an opacity value may be used to determine whether or not a ray should pass through the primitive and/or whether or not a ray should reflect from the primitive and/or whether or not a ray should be refracted by the primitive.

In embodiments, if a determined property value indicates that a primitive sub-region is opaque, (the current) ray tracing acceleration data structure traversal for the ray may terminate, e.g. with the (current) closest hit being determined. In embodiments, if a determined property value indicates that a primitive sub-region is transparent, (the current) ray tracing acceleration data structure traversal for the ray may continue (e.g. without a (current) closest hit being determined). In embodiments, if a determined property value indicates that a primitive sub-region has unknown or partial transparency or opacity, execution of a shader program may be triggered in order to determine whether and/or how a ray interacts with the primitive sub-region.

Each embodiment of the technology described herein can, and in embodiments does, include one or more, and in embodiments all, features of other embodiments of the technology described herein, as appropriate.

The technology described herein can be implemented in any suitable system, such as a suitably configured micro-processor based system. In embodiments, the technology described herein is implemented in a computer and/or micro-processor based system. The technology described herein is in embodiments implemented in a portable device, such as, and in embodiments, a mobile phone or tablet.

The technology described herein is applicable to any suitable form or configuration of graphics processor and graphics processing system, such as graphics processors (and systems) having a “pipelined” arrangement (in which case the graphics processor executes a rendering pipeline).

In embodiments, the various functions of the technology described herein are carried out on a single data processing platform that generates and outputs data, for example for a display device.

As will be appreciated by those skilled in the art, the data/graphics processing system may include, e.g., and in embodiments, a host processor that, e.g., executes applications that require processing by the graphics processor. The host processor will send appropriate commands and data to the graphics processor to control it to perform graphics processing operations and to produce graphics processing output required by applications executing on the host processor. To facilitate this, the host processor should, and in embodiments does, also execute a driver for the processor and optionally a compiler or compilers for compiling (e.g. shader) programs to be executed by (e.g. an (programmable) execution unit of) the processor.

The graphics processor and/or graphics processing system may also comprise, and/or be in communication with, one or more memories and/or memory devices that store the data described herein, and/or store software (e.g. (shader) program) for performing the processes described herein. The processor and/or system may also be in communication with and/or include a host microprocessor, and/or with a display for displaying images based on data generated by the processor/system.

The technology described herein can be used for all forms of input and/or output that a graphics processor may use or generate. For example, the graphics processor may execute a graphics processing pipeline that generates frames for display, render-to-texture outputs, etc. The output data values from the processing are in embodiments exported to external, e.g. main, memory, for storage and use, such as to a frame buffer for a display.

The various functions of the technology described herein can be carried out in any desired and suitable manner. For example, the functions of the technology described herein can be implemented in hardware or software, as desired. Thus, for example, the various functional elements, stages, and “means” of the technology described herein may comprise a suitable processor or processors, controller or controllers, functional units, circuitry, circuit(s), processing logic, microprocessor arrangements, etc., that are operable to perform the various functions, etc., such as appropriately dedicated hardware elements (processing circuit(s)) and/or programmable hardware elements (processing circuit(s)) that can be programmed to operate in the desired manner.

It should also be noted here that, as will be appreciated by those skilled in the art, the various functions, etc., of the technology described herein may be duplicated and/or carried out in parallel on a given processor. Equally, the various processing stages may share processing circuit(s), etc., if desired.

Furthermore, any one or more or all of the processing stages of the technology described herein may be embodied as processing stage circuitry/circuits, e.g., in the form of one or more fixed-function units (hardware) (processing circuitry/circuits), and/or in the form of programmable processing circuitry/circuits that can be programmed to perform the desired operation. Equally, any one or more of the processing stages and processing stage circuitry/circuits of the technology described herein may be provided as a separate circuit element to any one or more of the other processing stages or processing stage circuitry/circuits, and/or any one or more or all of the processing stages and processing stage circuitry/circuits may be at least partially formed of shared processing circuitry/circuits.

Subject to any hardware necessary to carry out the specific functions discussed above, the components of the graphics processing system can otherwise include any one or more or all of the usual functional units, etc., that such components include.

It will also be appreciated by those skilled in the art that all of the described embodiments of the technology described herein can include, as appropriate, any one or more or all of the optional features described herein.

The methods in accordance with the technology described herein may be implemented at least partially using software e.g. computer programs. It will thus be seen that when viewed from further embodiments the technology described herein provides computer software specifically adapted to carry out the methods herein described when installed on a data processor, a computer program element comprising computer software code portions for performing the methods herein described when the program element is run on a data processor, and a computer program comprising code adapted to perform all the steps of a method or of the methods herein described when the program is run on a data processing system. The data processing system may be a microprocessor, a programmable FPGA (Field Programmable Gate Array), etc.

The technology described herein also extends to a computer software carrier comprising such software which when used to operate a data processor, renderer or other system comprising a data processor causes in conjunction with said data processor said processor, renderer or system to carry out the steps of the methods of the technology described herein. Such a computer software carrier could be a physical storage medium such as a ROM chip, CD ROM, RAM, flash memory, or disk, or could be a signal such as an electronic signal over wires, an optical signal or a radio signal such as to a satellite or the like.

It will further be appreciated that not all steps of the methods of the technology described herein need be carried out by computer software and thus from a further broad embodiment the technology described herein provides computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions fixed on a tangible, non-transitory medium, such as a computer readable medium, for example, diskette, CD ROM, ROM, RAM, flash memory, or hard disk. It could also comprise a series of computer readable instructions transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink wrapped software, pre-loaded with a computer system, for example, on a system ROM or fixed disk, or distributed from a server or electronic bulletin board over a network, for example, the Internet or World Wide Web.

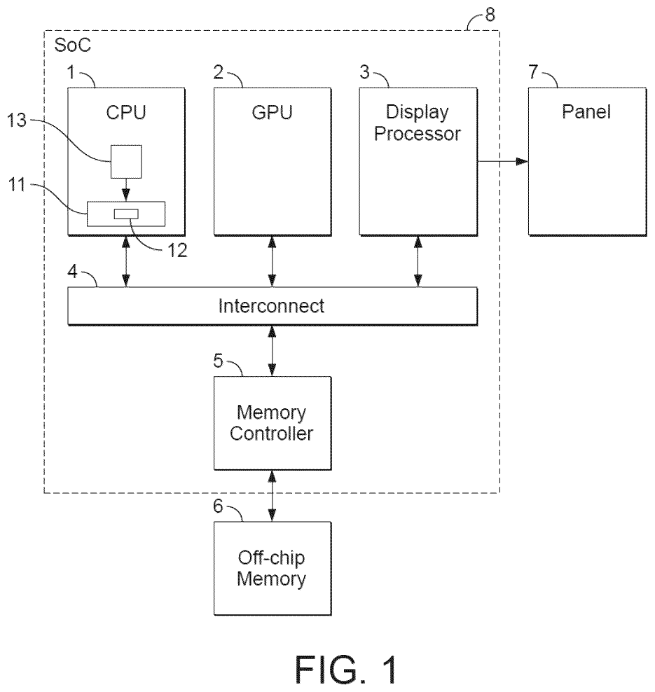

The present embodiments relate to the operation of a graphics processor, e.g. in a graphics processing system as illustrated in FIG. 1, when performing rendering of a scene to be displayed using a ray tracing-based rendering process.

Ray tracing is a rendering process which involves tracing the paths of rays of light from a viewpoint (sometimes referred to as a “camera”) back through sampling positions in an image plane (which is the frame being rendered) into a scene, and simulating the effect of the interaction between the rays and objects in the scene. The output data value e.g. colour of a sampling position in the image is determined based on the object(s) in the scene intersected by the ray passing through the sampling position, and the properties of the surfaces of those objects. The ray tracing process thus involves determining, for each sampling position, a set of (zero or more) objects within the scene which a ray passing through the sampling position intersects.

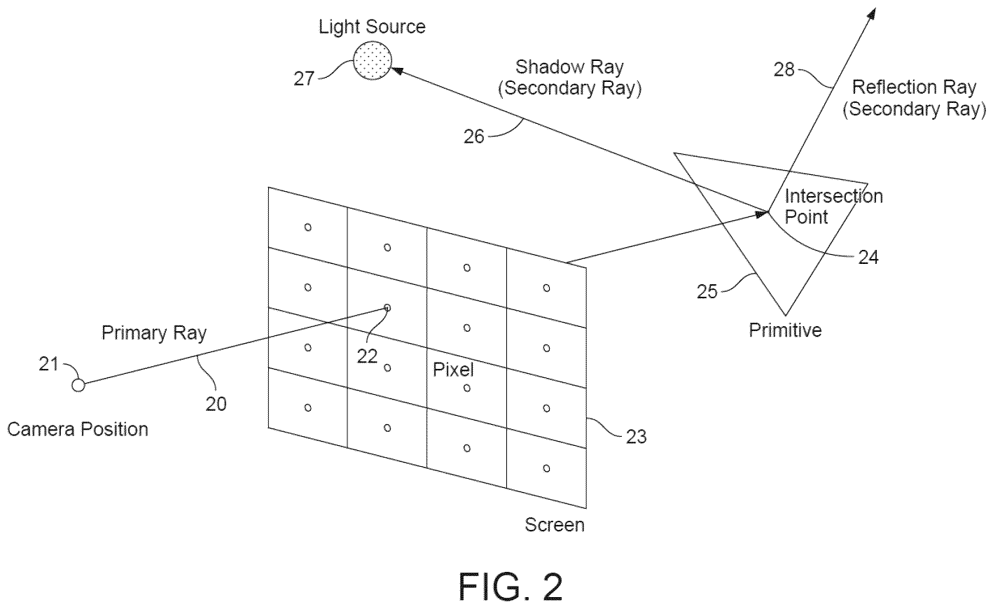

FIG. 2 illustrates an exemplary “full” ray tracing process. A ray 20 (the “primary ray”) is cast backward from a viewpoint 21 (e.g. camera position) through a sampling position 22 in an image plane (frame) 23 into the scene that is being rendered. The point 24 at which the ray 20 first intersects an object, which in this case is represented by a triangle primitive 25, in the scene is identified. This first intersection will be with the object in the scene closest to the sampling position.

A secondary ray in the form of shadow ray 26 may be cast from the first intersection point 24 to a light source 27. Depending upon the material of the surface of the object, another secondary ray in the form of reflected ray 28 may be traced from the intersection point 24. If the object is, at least to some degree, transparent, then a refracted secondary ray may be considered.

Such casting of secondary rays may be used where it is desired to add shadows and reflections into the image. A secondary ray may be cast in the direction of each light source (and, depending upon whether or not the light source is a point source, more than one secondary ray may be cast back to a point on the light source).

In the example shown in FIG. 2, only a single bounce of the primary ray 20 is considered, before tracing the reflected ray back to the light source. However, a higher number of bounces may be considered if desired.

The output data for the sampling position 22 i.e. a colour value (e.g. RGB value) thereof, is then determined taking into account the interactions of the primary, and any secondary, ray(s) cast, with objects in the scene. The same process is conducted in respect of each sampling position to be considered in the image plane (frame) 23.

Thus, different types of rays may be traced, depending on the scene, etc. Primary, reflection and refraction rays may be referred to as “closest-hit rays”, since they are typically traced until intersecting geometry closest to the ray's origin is found (or until it is determined that the ray does not intersect any geometry). On the other hand, shadow rays may be referred to as “first-hit rays” or “visibility rays”, as they can typically be terminated as soon as they are found to intersect any geometry (or until it is determined that the ray does not intersect any geometry).

In order to facilitate such ray tracing processing, in the present embodiments, acceleration data structures indicative of the geometry (e.g. objects) in scenes to be rendered are used when determining the intersection data for the ray(s) associated with a sampling position in the image plane to identify a subset of the geometry which a ray may intersect.

The ray tracing acceleration data structure represents and indicates the distribution of geometry (e.g. objects) in the scene being rendered, and in particular the geometry that falls within respective (sub-) volumes in the overall volume of the scene (that is being considered).

In the present embodiments, a ray tracing acceleration data structure is in the form of one or more Bounding Volume Hierarchy (BVH) trees. The use of BVH trees allows and facilitates testing a ray against a hierarchy of bounding volumes until a leaf node is found. It is then only necessary to test the geometry associated with the particular leaf node for intersection with the ray.

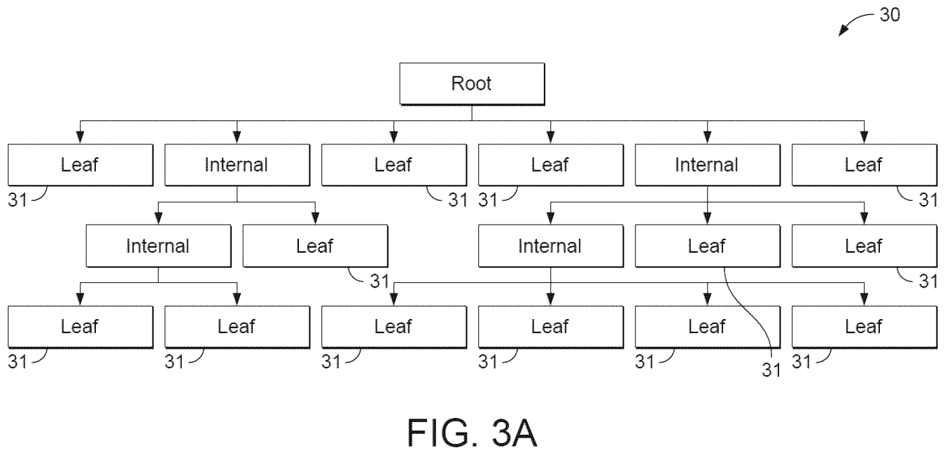

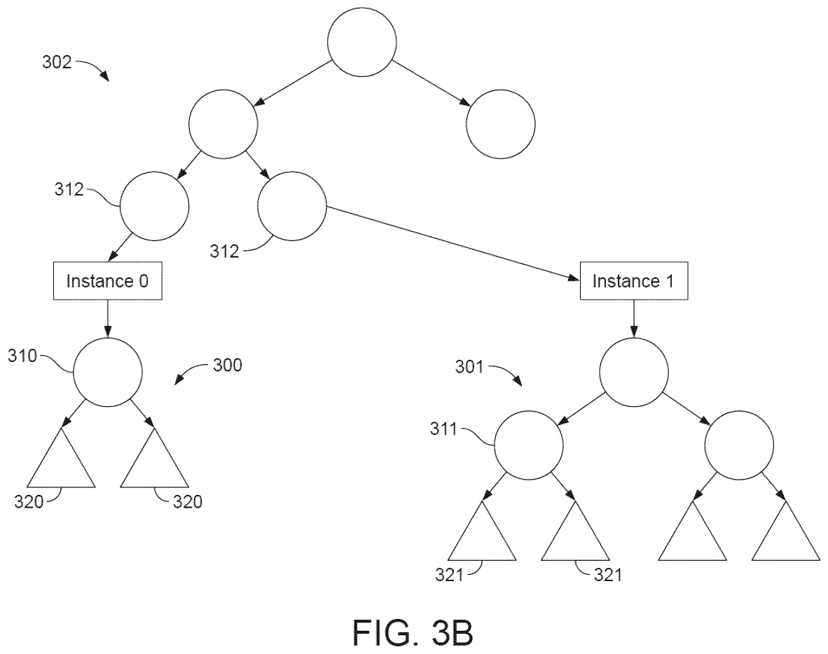

FIG. 3A shows an exemplary BVH tree 30, constructed by enclosing a volume in an axis-aligned bounding volume (AABV), e.g. a cube, and then recursively sub-dividing the bounding volume into successive sub-AABVs according to any suitable and desired sub-division scheme, until a desired smallest sub-division (volume) is reached.

In this example, the BVH tree 30 is a relatively “wide” tree wherein each bounding volume is sub-divided into up to six sub-AABVs. However, in general, any other suitable tree structure may be used, and a given node of the tree may have any suitable and desired number of child nodes.

Thus, each node in the BVH tree 30 will have a respective volume associated with it, with the end, leaf nodes 31 each representing a particular smallest sub-divided volume, and any parent node representing, and being associated with, the volume of its child nodes.

A complete scene may be represented by a single BVH tree, e.g. with the tree storing the geometry for the scene, e.g. in world space. In this case, each leaf node of the BVH tree 30 may be associated with the geometry defined for the scene that falls, at least in part, within the volume that the leaf node corresponds to (e.g. whose centroid falls within the volume in question). The leaf nodes 31 may represent unique (non-overlapping) subsets of primitives defined for the scene falling within the corresponding volumes for the leaf nodes 31.

In the present embodiments, a two-level ray tracing acceleration data structure is used. FIG. 3B shows an exemplary two-level ray tracing acceleration data structure in which each instance or object is associated with a respective bottom-level acceleration structure (BLAS) 300, 301, which in the present embodiments is in the form of a respective BVH tree that stores geometry in a model space, with each leaf node 310, 311 of the BVH tree representing a unique subset of primitives 320, 321 defined for the instance or object falling within the corresponding volume.

A separate top-level acceleration structure (TLAS) 302 then contains references to the set of bottom-level acceleration structures (BLAS), together with a respective set of shading and transformation information for each bottom-level acceleration structure (BLAS). In the present embodiments, the top-level acceleration structure (TLAS) 302 is defined in a “top-level” space (e.g. world space) and is in the form of a BVH tree having leaf nodes 312 that each point to one or more of the bottom-level acceleration structures (BLAS) 300, 301.

Other forms of ray tracing acceleration data structure would be possible.

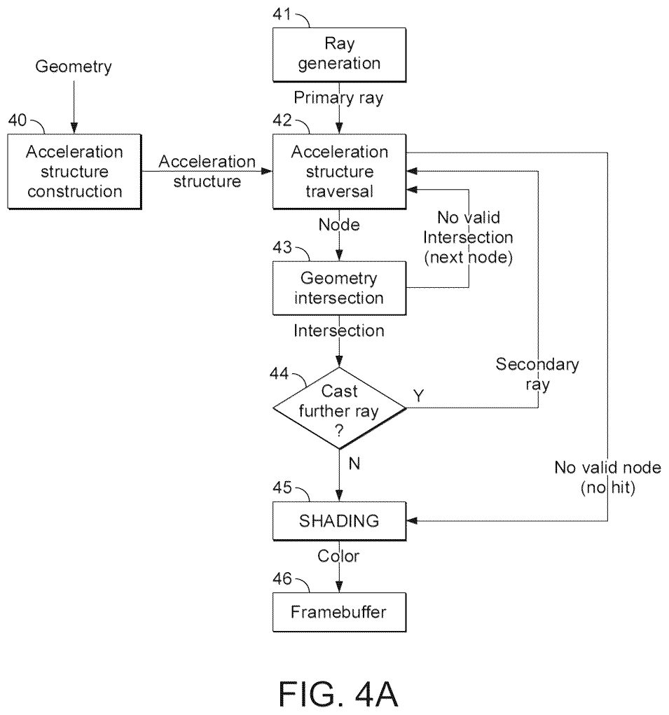

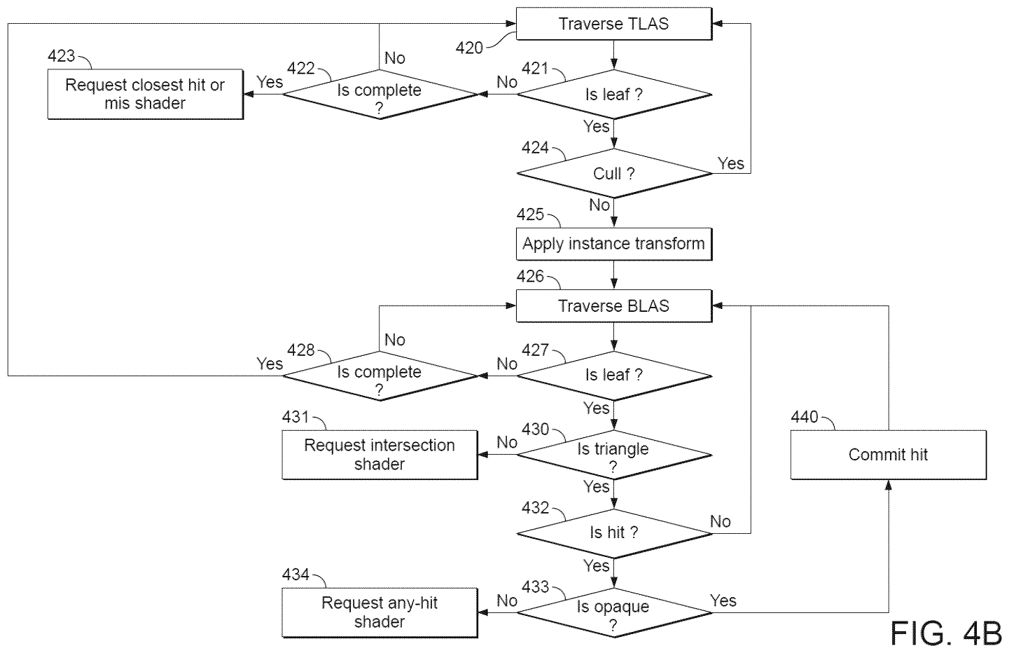

FIG. 4A is a flow chart showing an overall ray tracing process that may be performed on and by the graphics processor 2.

First, the geometry of the scene is analysed and used to obtain an acceleration data structure (step 40), for example in the form of one or more BVH tree structures, as discussed above. This can be done in any suitable and desired manner, for example by means of an initial processing pass on the graphics processor 2.

A primary ray is then generated, passing from a camera through a particular sampling position in an image plane (frame) (step 41). The acceleration data structure is then traversed for the primary ray (step 42), and the leaf node corresponding to the first volume that the ray passes through which contains geometry which the ray potentially intersects is identified. It is then determined whether the ray intersects any of the geometry, e.g. primitives, (if any) in that leaf node (step 43).

If no (valid) geometry which the ray intersects can be identified in the node, the process returns to step 42, and the ray continues to traverse the acceleration data structure and the leaf node for the next volume that the ray passes through which may contain geometry with which the ray intersects is identified, and a test for intersection performed at step 43.

This is repeated for each leaf node that the ray (potentially) intersects, until geometry that the ray intersects is identified.

When geometry that the ray intersects is identified, it may be determined whether that intersection is the “closest” hit so far, for example, and if so, for example, then determined whether to cast any further (secondary) rays for the primary ray (and thus sampling position) in question (step 44). This may be based, e.g., and in an embodiment, on the nature of the geometry (e.g. its surface properties) that the ray has been found to intersect, and the complexity of the ray tracing process being used.

Thus, as shown in FIG. 4A, one or more secondary rays may be generated emanating from the intersection point (e.g. a shadow ray(s), a refraction ray(s) and/or a reflection ray(s), etc.). Steps 42, 43 and 44 are then performed in relation to each secondary ray. A secondary ray may be generated as part of a shading process, for example.

Once there are no further rays to be cast, a shaded colour for the sampling position that the ray(s) correspond to is then determined based on the result(s) of the casting of the primary ray, and any secondary rays considered (step 45), taking into account the properties of the surface of the object at the primary intersection point, any geometry intersected by secondary rays, etc. The shaded colour for the sampling position is then stored in the frame buffer (step 46).

If no (valid) node which may include geometry intersected by a given ray (whether primary or secondary) can be identified in step 42 (and there are no further rays to be cast for the sampling position), the process moves to step 45, and shading is performed. In this case, the shading is in an embodiment based on some form of “default” shading operation that is to be performed in the case that no intersected geometry is found for a ray. This could comprise, e.g., simply allocating a default colour to the sampling position, and/or having a defined, default geometry to be used in the case where no actual geometry intersection in the scene is found, with the sampling position then being shaded in accordance with that default geometry. Other arrangements are possible.

This process is performed for each sampling position to be considered in the image plane (frame). Once the final output value for the sampling position in question has been generated, the processing in respect of that sampling position is completed. A next sampling position may then be processed in a similar manner, and so on, until all the sampling positions for the frame have been appropriately shaded. The frame may then be output, e.g. for display, and the next frame to be rendered processed in a similar manner, and so on.

FIG. 4B is a flow chart showing in more detail acceleration structure traversal in the case of a two-level acceleration data structure, e.g. as described above with reference to FIG. 3B. As shown in FIG. 4B, in this case, acceleration structure traversal begins with TLAS traversal (step 420), and TLAS traversal continues in search of a TLAS leaf node (steps 421, 422). If no TLAS leaf node can be identified, a “default” shading operation (“miss shader”) may be performed (step 423), e.g. as described above.

When (at step 421) a TLAS leaf node is identified, it is determined whether that leaf node can be culled from further processing (step 424). If it can be culled from further processing, the process returns to TLAS traversal (step 420).

If the TLAS leaf node cannot be culled from further processing, instance transform information associated with the leaf node is used to transform the ray to the appropriate space for BLAS traversal (step 425). BLAS traversal then begins (step 426), and continues in search of a BLAS leaf node (steps 427, 428). If no BLAS leaf node can be identified, the process may return to TLAS traversal (step 420).

In the present embodiments, geometry associated with a BLAS leaf node can be in the form of a set of triangle primitives or an axis aligned bounding box (AABB) primitive. When (at step 427) a BLAS leaf node is identified, it is determined whether geometry associated with the leaf node is in the form of a set of triangle primitives or an axis aligned bounding box (AABB) primitive (step 430).

As shown in FIG. 4B, when an axis aligned bounding box (AABB) primitive is encountered, execution of a shader program (“intersection shader”) that defines a procedural object encompassed by the axis aligned bounding box (AABB) is triggered (step 431) to determine whether a ray intersects the procedural object defined by the shader program. On the other hand, when a set of triangle primitives is encountered, determining whether a ray intersects any of the triangle primitives is performed by fixed function circuitry (circuit(s)) (step 432). Other arrangements would be possible.

If no (valid) triangle primitives which the ray intersects can be identified in the node, the process returns to BLAS traversal (step 426).

If a ray is found to intersect a triangle primitive 25, it is determined whether or not the triangle primitive 25 is opaque at the intersection point 24 (step 433). In the case of the triangle primitive intersection point 24 being found to be non-opaque, execution of an appropriate shader program (“any-hit shader”) may be triggered (step 434). Otherwise, in the case of the triangle primitive intersection point 24 being found to be opaque, the intersection can be committed without executing a shader program (step 440). Traversal for one or more secondary rays may be triggered, as appropriate, e.g. as discussed above.

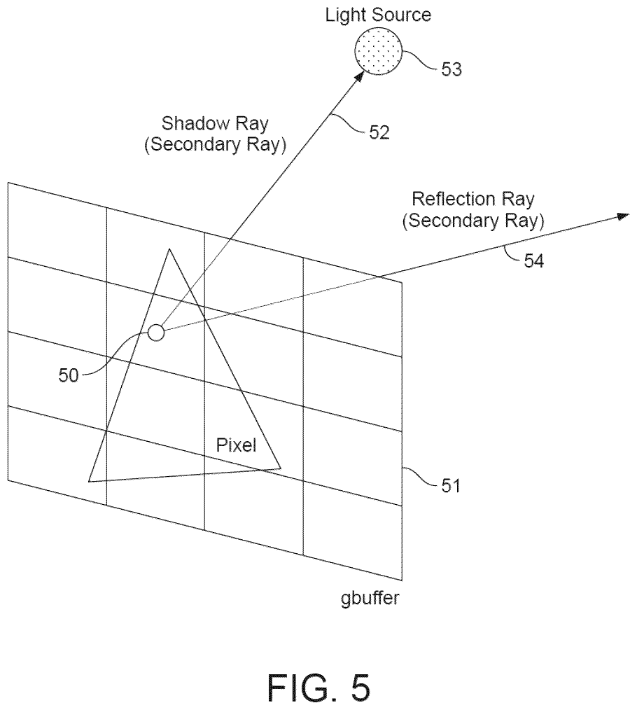

FIG. 5 shows an alternative ray tracing process which may be used in embodiments of the technology described herein, in which only some of the steps of the full ray tracing process described above are performed. Such an alternative ray tracing process may be referred to as a “hybrid” ray tracing process.

In this process, as shown in FIG. 5, the first intersection point 50 for each sampling position in the image plane (frame) is instead determined first using a rasterisation process and stored in an intermediate data structure known as a “G-buffer” 51. Thus, the process of generating a primary ray for each sampling position, and identifying the first intersection point of the primary ray with geometry in the scene, is replaced with an initial rasterisation process to generate the “G-buffer”. The G-buffer includes information indicative of the depth, colour, normal and surface properties (and any other appropriate and desired data, e.g. albedo, etc.) for each first (closest) intersection point for each sampling position in the image plane (frame).

Secondary rays, e.g. shadow ray 52 to light source 53, and reflection ray 54, may then be cast starting from the first intersection point 50, and the shading of the sampling positions determined based on the properties of the geometry first intersected, and the interactions of the secondary rays with geometry in the scene.

Referring to the flowchart of FIG. 4A, in such a hybrid process, the initial pass of steps 41, 42 and 43 of the full ray tracing process for a primary ray will be omitted, as there is no need to cast primary rays and determine their first intersection with geometry in the scene. The first intersection point data for each sampling position is instead obtained from the G-buffer.

The process may then proceed to the shading stage 45 based on the first intersection point for each pixel obtained from the G-buffer, or where secondary rays emanating from the first intersection point are to be considered, these will need to be cast in the manner described by reference to FIG. 4. Thus, steps 42, 43 and 44 will be performed in the same manner as previously described in relation to the full ray tracing process for any secondary rays.

The colour determined for a sampling position will be written to the frame buffer in the same manner as step 46 of FIG. 4A, based on the shading colour determined for the sampling position based on the first intersection point (as obtained from the G-buffer), and, where applicable, the intersections of any secondary rays with objects in the scene, determined using ray tracing.

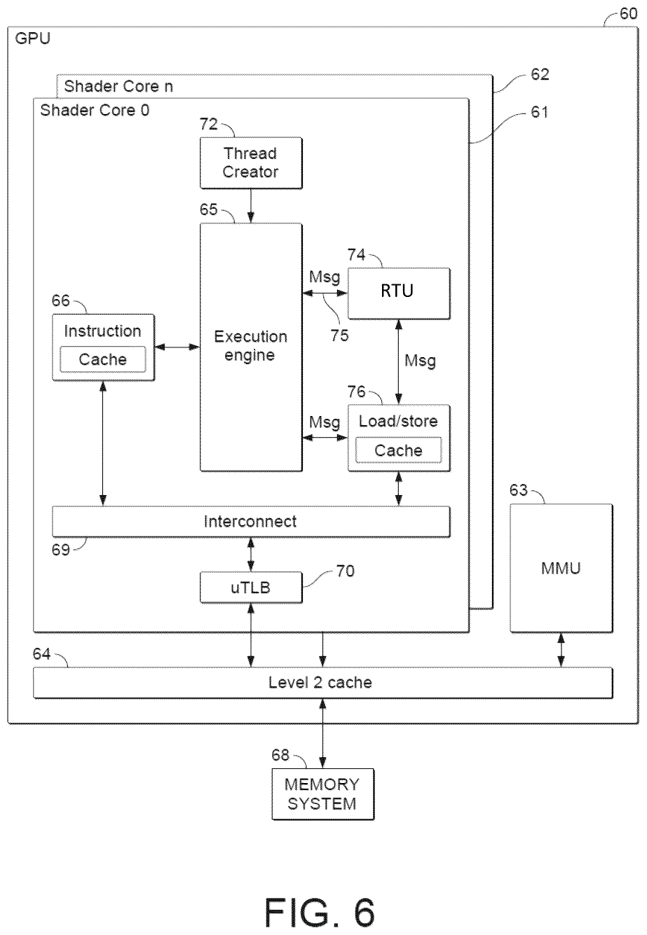

FIG. 6 shows schematically the relevant elements and components of a graphics processor (GPU) 2, 60 of the present embodiments.

As shown in FIG. 6, the GPU 60 includes one or more shader (processing) cores 61, 62 together with a memory management unit (“MMU”) 63 and a level 2 cache 64 which is operable to communicate with an off-chip memory system 6, 68 (e.g. via an appropriate interconnect and (dynamic) memory controller).

FIG. 6 shows schematically the relevant configuration of one shader core 61, but as will be appreciated by those skilled in the art, any further shader cores of the graphics processor 60 will be configured in a corresponding manner.

The graphics processor (GPU) shader cores 61, 62 are programmable processing units (circuits) that perform processing operations by running small programs for each “item” in an output to be generated such as a render target, e.g. frame. An “item” in this regard may be, e.g. a vertex, one or more sampling positions, etc. The shader cores will process each “item” by means of one or more execution threads which will execute the instructions of the shader program(s) in question for the “item” in question. Typically, there will be multiple execution threads each executing at the same time (in parallel).

FIG. 6 shows the main elements of the graphics processor 60 that are relevant to the operation of the present embodiments. As will be appreciated by those skilled in the art there may be other elements of the graphics processor 60 that are not illustrated in FIG. 6. It should also be noted here that FIG. 6 is only schematic, and that, for example, in practice the shown functional units may share significant hardware circuits, even though they are shown schematically as separate units in FIG. 6. It will also be appreciated that each of the elements and units, etc., of the graphics processor as shown in FIG. 6 may, unless otherwise indicated, be implemented as desired and will accordingly comprise, e.g., appropriate circuits (processing logic), etc., for performing the necessary operation and functions.

As shown in FIG. 6, each shader core of the graphics processor 60 includes an appropriate programmable execution unit (execution engine) 65 that is operable to execute graphics shader programs for execution threads to perform graphics processing operations.

The shader core 61 also includes an instruction cache 66 that stores instructions to be executed by the programmable execution unit 65 to perform graphics processing operations. The instructions to be executed will, as shown in FIG. 6, be fetched from the memory system 68 via an interconnect 69 and a micro-TLB (translation lookaside buffer) 70.

The shader core 61 also includes an appropriate load/store unit 76 in communication with the programmable execution unit 65, that is operable, e.g., to load into an appropriate cache, data, etc., to be processed by the programmable execution unit 65, and to write data back to the memory system 68 (for data loads and stores for programs executed in the programmable execution unit). Again, such data will be fetched/stored by the load/store unit 76 via the interconnect 69 and the micro-TLB 70.

In the present embodiments, the main (e.g. off-chip) memory 6, 68 is configured to access data in fixed bursts/blocks of data, for example 64-byte naturally aligned blocks of data, to maximise memory access efficiency. The graphics processor cache memory, and cache line size is similarly arranged to fetch blocks of data in this manner.

In order to perform graphics processing operations, the programmable execution unit 65 will execute graphics shader programs (sequences of instructions) for respective execution threads (e.g. corresponding to respective sampling positions of a frame to be rendered). Accordingly, as shown in FIG. 6, the shader core 61 further comprises a thread creator (generator) 72 operable to generate execution threads for execution by the programmable execution unit 65.

As shown in FIG. 6, the shader core 61 in this embodiment also includes a ray tracing circuit (unit) (“RTU”) 74, which is in communication with the programmable execution unit 65, and which is operable to perform the required ray-volume testing during the ray tracing acceleration data structure traversals (e.g. the operation of steps 420 and 426 of FIG. 4B) for rays being processed as part of a ray tracing-based rendering process, in response to messages 75 received from the programmable execution unit 65.

In the present embodiments the RTU 74 is also operable to perform the required ray-triangle testing (e.g. the operation of step 432 of FIG. 4B). The RTU 74 is also able to communicate with the load/store unit 76 for loading in the required data for such intersection testing.

In the present embodiments, the RTU 74 of the graphics processor is a (substantially) fixed-function hardware unit (circuit) that is configured to perform the required ray-volume and ray-triangle intersection testing during a traversal of a ray tracing acceleration data structure to determine geometry for a scene to be rendered that may be (and is) intersected by a ray being used for a ray tracing operation. However, some amount of configurability may be provided.

Other arrangements would be possible. For example, ray-volume and/or ray-triangle intersection testing may be performed by the programmable execution unit 65 (e.g. in software).

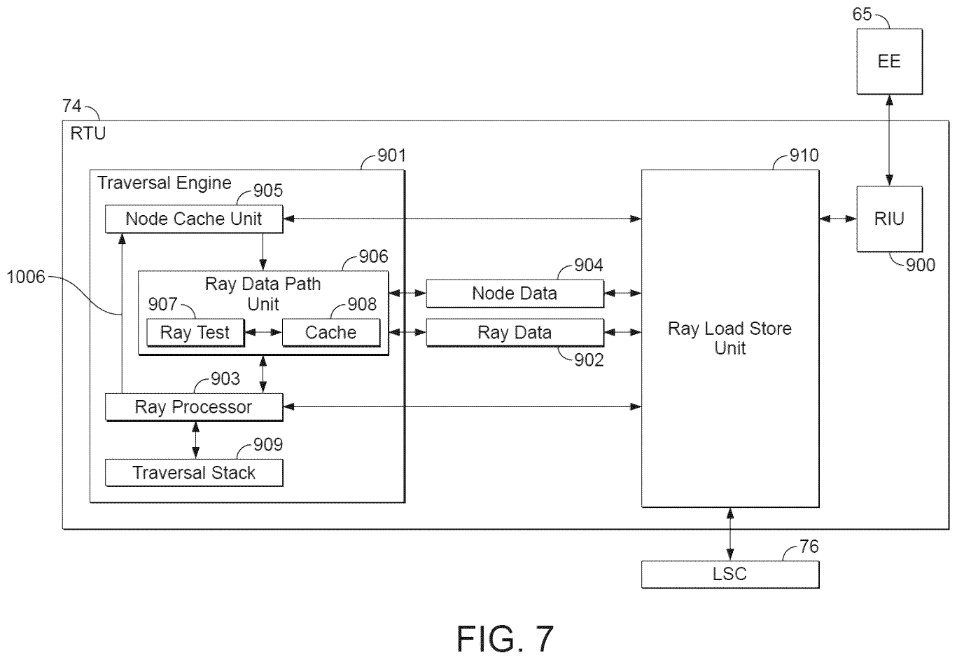

FIG. 7 shows the ray tracing unit (circuit) (RTU) 74 in more detail. The ray tracing unit 74 performs the ray tracing acceleration data structure traversals for rays that are to be traced, and includes, as shown in FIG. 7, a traversal engine (unit) 901 for doing that.

The traversal engine 901 includes a ray testing circuit in the form of a ray data path unit 906 that performs ray-node (intersection) tests for the traversal operations. To do this, the ray testing circuit (ray data path unit) 906 includes a plurality of ray testing units (circuits) 907, each operable to perform a particular type of ray-node test.

In the present embodiments, the ray testing circuit (ray data path unit) 906 includes as its ray testing units 907, one or more ray testing units configured to perform tests for non-end (non-leaf) nodes (“box” nodes) of a ray tracing acceleration data structure, one or more ray testing units configured to perform ray-node tests for (TLAS) end (leaf) nodes that indicate a transition from one ray tracing acceleration data structure to another (“transform” nodes), and one or more ray testing units configured to perform ray-node tests for (BLAS) end (leaf) nodes of a ray tracing acceleration data structure that indicate actual geometry to be tested (“triangle” nodes). Other arrangements are possible.

In order to perform the ray-node tests, the respective ray node testing units are provided with the appropriate ray and node data. To facilitate this, as shown in FIG. 7, data of nodes and rays to be tested is stored locally in the ray tracing unit 74 in a node data store 904 and a ray data store 902, respectively. As shown in FIG. 7, the ray data path unit 906 further includes node storage 908 local to the ray data path unit, in which ray tracing acceleration structure node data is stored for use by the ray testing units 907 when performing ray-node tests.

As shown in FIG. 7, the traversal engine 901 also includes a ray processing unit (ray processor) 903 that has an associated traversal stack 909. The ray processing unit 903 controls the overall traversal process for rays that are to be traced by the traversal unit 901. The traversal stack 909 is used to keep track of the traversal progress of rays that are being traced through a ray tracing acceleration data structure.

As shown in FIG. 7, the traversal engine 901 also includes a node cache unit/controller 905. The node cache unit 905 operates to coordinate and schedule the ray-node tests on the ray data path unit 906, and to ensure that the appropriate ray and node data is provided to the desired ray testing unit for the required ray-node tests. The ray processing unit 903 issues messages to the node cache unit 905 indicating a ray and ray tracing acceleration data structure node combination that is to be tested by the ray data path unit 906, and the ray data path unit 906 performs the ray-node testing under the control of the node cache unit 905.

The tracing of rays by the ray tracing unit 74 is triggered by appropriate messages from the execution engine 65 (in response to “ray tracing” instructions in a shader program that the execution engine is executing). To facilitate this, as shown in FIG. 7, the ray tracing unit 74 includes a ray instruction unit (RIU) 900 that receives the messages from the execution engine 65 of a shader core when ray tracing is to be performed for respective rays. The ray instruction unit 900 correspondingly returns respective rays to the execution engine 65 for further processing when required.

In response to a message from the execution engine 65 to perform ray tracing for a ray or rays, the ray instruction unit 900 controls a ray load store unit (RLSU) 910 to create an appropriate set of one or more rays to be processed. For each ray to be traced, the ray load store unit 910 loads the relevant ray data to the ray data store 902. The ray load store unit 910 signals the ray processing unit 903 to perform the required ray tracing acceleration data structure traversal for the ray, and appropriate node data is loaded into the node data store 904 by the ray load store unit in response to requests to do that sent by the node cache unit 905.

As shown in FIG. 7, the ray load store unit 910 has an appropriate interface to the load store cache 76 via which it can load ray data from the memory system into the ray data store 902, and load node data from the memory system into the node data store 904, as and when required. The ray data path unit 906 may also write any resulting ray data from its testing to the ray data store 902, for example for returning to memory via the load store cache 76, as appropriate.

The process of determining whether a triangle primitive intersection point 24 is opaque (e.g. step 433 of FIG. 4B) can typically involve retrieving and sampling an alpha texture for the intersected triangle primitive 25. However, it has been recognised that this can be associated with significant processing, memory and bandwidth requirements.

One way to accelerate the determination of whether a triangle primitive intersection point 24 is opaque (e.g. step 433 of FIG. 4B) is the use of opacity micromaps. An opacity micromap (barycentrically) sub-divides a triangle primitive into a micromesh of equally sized and shaped sub-triangles, and encodes opacity information for each sub-triangle. This can allow fine detail opacity information to be more efficiently encoded and processed, e.g. as compared to more traditional texture-based approaches.

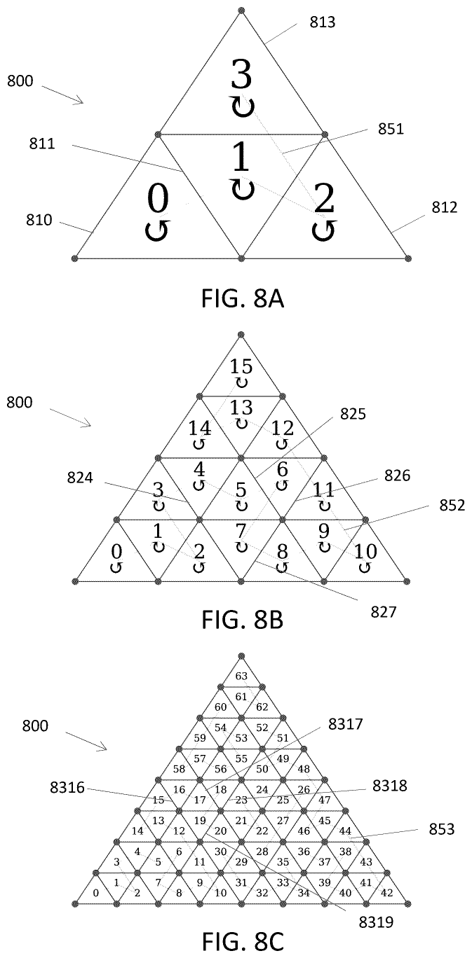

FIG. 8 illustrates micromap sub-division of a triangle primitive 800 into three different possible micromeshes of sub-triangles.

FIG. 8A shows a first “level” of sub-division, in which a triangle primitive 800 is sub-divided into a micromesh of four equally sized and shaped sub-triangles 810-813. As illustrated in FIG. 8A, each such first-level sub-triangle 810-813 is associated with an index (0-3) that uniquely identifies the respective first-level sub-triangle (at the first sub-division level). As illustrated in FIG. 8A, the indices are defined in a predetermined (e.g. API defined) order on the basis of a first-level area filling curve 851.

In these examples, as illustrated in FIG. 8, an area filling curve is based on traversing triangle edges with alternating winding directions (e.g. as described in the Vulkan specification). Other arrangements may be possible.

FIG. 8B shows a second level of sub-division, in which triangle primitive 800 is sub-divided into a micromesh of sixteen equally sized and shaped sub-triangles. In this case, each of the first-level sub-triangles 810-813 is effectively sub-divided into four equally sized and shaped second-level sub-triangles. For example, first-level sub-triangle 811 is sub-divided into four second-level sub-triangles 824-827. As illustrated in FIG. 8B, each second-level sub-triangle is associated with an index (0-15) that uniquely identifies the respective second-level sub-triangle (at the second sub-division level). As illustrated in FIG. 8B, the indices are defined in a predetermined (e.g. API defined) order on the basis of a second-level area filling curve 852.

FIG. 8C shows a third level of sub-division, in which triangle primitive 800 is sub-divided into a micromesh of sixty-four equally sized and shaped sub-triangles. In this case, each of the second-level sub-triangles is effectively sub-divided into four equally sized and shaped third-level sub-triangles. For example, second-level sub-triangle 824 is sub-divided into four third-level sub-triangles 8316-8319. As illustrated in FIG. 8C, each third-level sub-triangle is associated with an index (0-63) that uniquely identifies the respective third-level sub-triangle (at the third sub-division level). As illustrated in FIG. 8C, the indices are defined in a predetermined (e.g. API defined) order on the basis of a third-level area filling curve 853.

Higher sub-division levels can be defined in a similar manner, i.e. by sub-dividing a triangle primitive into a micromesh of 2²ⁿ (2\hat{ }(2n)) equally sized and shaped sub-triangles, where n is the (integer) sub-division level. In principle, any sub-division level would be possible. In practice, there may typically be an upper limit on sub-division level, such as n≤16.

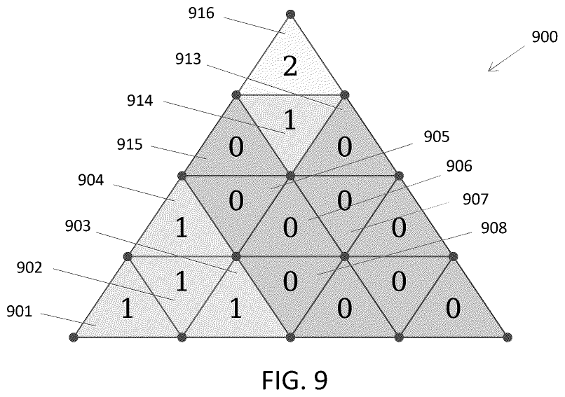

FIG. 9 shows an exemplary “second-level” opacity micromap 900 that defines a respective opacity value for each second-level sub-triangle. In this example, each opacity value can indicate one of four possible states and is encoded as two-bits per sub-triangle: a value of “0” indicating fully transparent, a value of “1” indicating fully opaque, a value “2” indicating partially transparent, and a value of “3” indicating partially opaque.

In the present embodiments, if an opacity value of “0” (indicating fully transparent) is found at intersection point 24, the ray-triangle intersection event may be effectively ignored, and the process may return to acceleration data structure traversal. If an opacity value of “2” or “3” (indicating partially transparent or opaque) is found at intersection point 24, execution of an appropriate shader program (“any-hit shader”) may be triggered (e.g. corresponding to step 434 of FIG. 4B). Otherwise, if an opacity value of “1” (indicating fully opaque) is found at intersection point 24, the intersection may be committed without executing a shader program (e.g. corresponding to step 440 of FIG. 4B).

Other encodings are possible. For example, it is possible for an opacity value to indicate one of two possibilities: e.g. a value of “0” indicating transparent, and a value of “1” indicating opaque, and encoded as a single bit per sub-triangle.

Micromap opacity values could be handled separately to data defining a corresponding triangle primitive. However, in the present embodiments, triangle primitive and (at least some) micromap opacity data are handled and stored together. This can facilitate improved memory access efficiency.

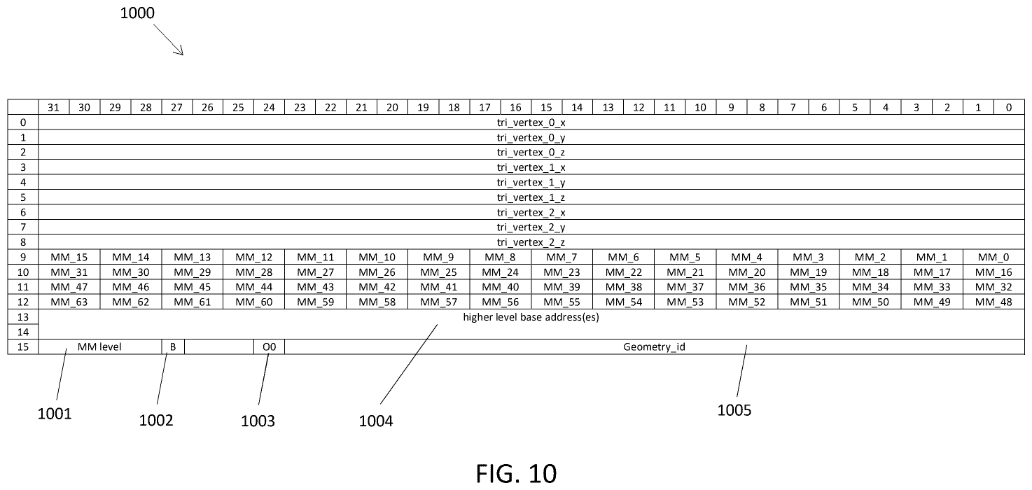

For example, FIG. 10 shows a data structure 1000 for storing triangle primitive data and micromap opacity data together, in accordance with embodiments. The data structure shown in FIG. 10 is a 64-byte data structure comprising 16 lines each capable of storing 32 bits. This data structure is thus aligned with the size of cache lines and memory transactions (i.e. can fit within one 64-byte cache line). This allows data defining a triangle primitive and corresponding micromap opacity data to be fetched (loaded) together in a single read operation by load/store unit 76.

As shown in FIG. 10, in the present embodiment, data structure 1000 stores a triangle comprising three vertices, with three co-ordinates (x,y,z) being stored for each vertex. Each vertex co-ordinate is stored as 32-bit floating point value (where ‘tri_vertex_0_x’ represents the x co-ordinate of the first vertex (vertex 0) for the triangle primitive, ‘tri_vertex_0_y’ and ‘tri_vertex_0_z’ are the corresponding y and z co-ordinates, and so on).

Micromap opacity data for the triangle primitive is also stored in the same data structure 1000. As illustrated in FIG. 10, in the present embodiment, data structure 1000 can store up to 64 two-bit opacity values (MM_0, MM_1, . . . , MM_63). Data structure 1000 can thus directly store (together with vertex data defining a triangle primitive) opacity data defining a first-level, second-level or third-level two-bit opacity micromap.

Support for higher-level (n>3) opacity micromaps could be provided by increasing the size of data structure 1000 so as to be able to store more opacity values. The inventors have found, however, that this can reduce overall efficiency. In the present embodiments, support for higher-level opacity micromaps is provided by storing higher-level micromap opacity data separately in one or more further cache aligned data structures.

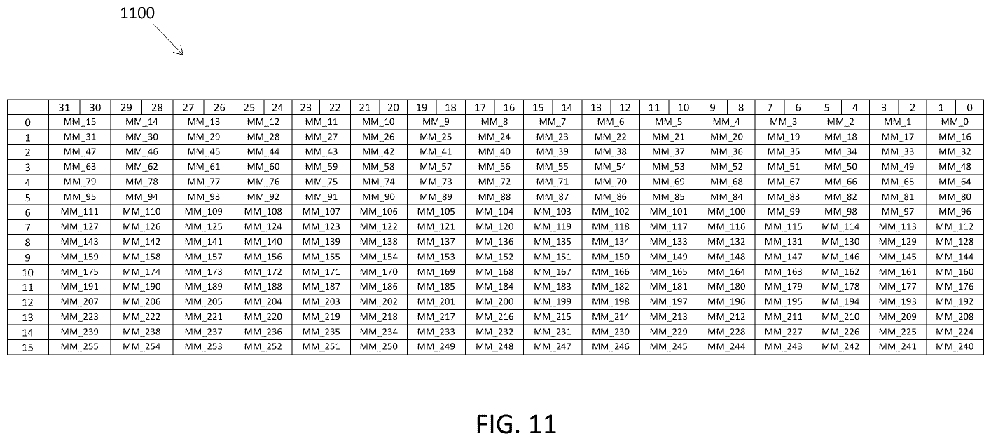

FIG. 11 shows a data structure 1100 for storing higher-level micromap opacity data, in accordance with embodiments. The data structure shown in FIG. 11 is again a 64-byte data structure comprising 16 lines each capable of storing 32 bits. This data structure is thus aligned with the size of cache lines and memory transactions (i.e. can fit within one 64-byte cache line), and can be fetched (loaded) in a single read operation by load/store unit 76. As illustrated in FIG. 11, in the present embodiment, data structure 1100 can store up to 256 two-bit opacity values (MM_0, MM_1, . . . , MM_255). Alternatively, data structure 1100 may store up to 512 one-bit opacity values.

In the present embodiments, as shown in FIG. 10, in order to link different data structures that store data for the same micromap, the lower-level data structure 1000 can store one or more higher level base addresses 1004 that point to one or more higher-level data structures 1100 storing opacity data for the same micromap. The lower-level data structure 1000 also stores an indication 1001 of the level of the micromap that is being stored, and an indication 1002 of whether a linked higher-level data structure 1100 stores one-bit or two-bit opacity values.

Various other primitive data or metadata may also be stored in the lower-level data structure 1000. For instance, as shown in FIG. 10, there is also stored in the data structure a bit 1003 indicating whether the entirety of the triangle primitive is opaque (and thus whether an “any-hit shader” should be triggered, e.g. as discussed above). Also stored is a geometry ID 1005 that indicates the material that the triangle represents. The geometry ID 1005 may be used by a shader program to determine how to shade (e.g. determine a colour for) the corresponding geometry.

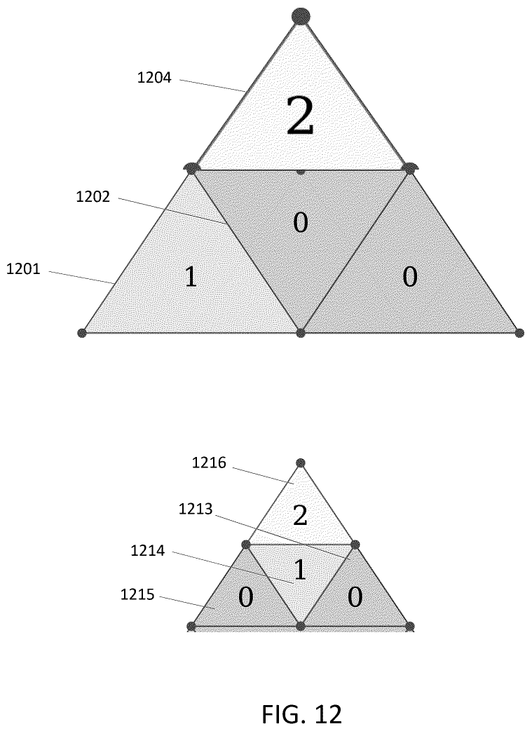

As many higher-level data structures 1100 as are required to store each individual opacity value of a higher-level (e.g. n>3) micromap could be provided. However, the inventors have found that it can often be the case that adjacent sub-triangles of a micromap share the same value, and that this can facilitate a reduction in storage requirements. This is illustrated by FIGS. 9 and 12.

FIG. 12 illustrates an efficient representation of the second-level opacity micromap 900 of FIG. 9, in accordance with embodiments. In this embodiment, if all opacity values for the second-level sub-triangles encompassed by a corresponding first-level sub-triangle are equal, a single opacity value representing all of the second-level sub-triangles encompassed by the first-level sub-triangle is stored, instead of storing separate opacity values for each of the second-level sub-triangles.

For example, since (as shown in FIG. 9) each opacity value for second-level sub-triangles 901-904 is equal to “1”, a single opacity value of “1” may be stored corresponding to first-level sub-triangle 1201 (as shown in FIG. 12). Similarly (as shown in FIG. 12), a single opacity value of “0” corresponding to first-level sub-triangle 1202 may be stored to represent all of the corresponding second-level sub-triangles 905-908 that have opacity values that are all equal to “0” (as shown in FIG. 9).

As shown in FIG. 9, second-level sub-triangles 913-916 have opacity values that are not all equal. In this case, as shown in FIG. 12, an indication that there are different opacity values for the corresponding second-level sub-triangles is stored for the corresponding first-level sub-triangle 1204, which indication is in the present embodiment a “2” (but could, e.g., be a “3” or other indication). As shown in FIG. 12, the individual second-level opacity values 1213-1216 are then stored separately. In this way, the second-level micromap of FIG. 9 that has 16 two-bit opacity values can be encoded by 8 two-bit values.

Returning FIGS. 10 and 11, in these embodiments, a higher-level (n>3) opacity micromap can be efficiently encoded in a corresponding manner, by storing in the lower-level data structure 1000 a two-bit value for each third-level sub-triangle. In these embodiments, a value of “0” stored in the lower-level data structure 1000 for a third-level sub-triangle indicates that all higher-level sub-triangles encompassed by the third-level sub-triangle have an opacity value equal to “0”. A value of “1” stored in the lower-level data structure 1000 for a third-level sub-triangle indicates that all higher-level sub-triangles encompassed by the third-level sub-triangle have an opacity value equal to “1”.

A value of “2” (or e.g. “3”) stored in the lower-level data structure 1000 for a third-level sub-triangle indicates that the higher-level sub-triangles encompassed by the third-level sub-triangle do not all have the same opacity value. In this case, one or more links 1004 to one or more higher-level data structures 1100 are stored in the lower-level data structure 1000, and the individual higher-level opacity values are stored separately in the one or more higher-level data structures 1100.

For example, in the case of a tenth-level (n=10) micromap, each of the 64 two-bit opacity data values (MM_0, MM_1, . . . , MM_63) stored in the lower-level data structure 1000 will correspond to a respective third-level sub-triangle that encompasses 16k respective tenth-level sub-triangles. Where all 16k tenth-level sub-triangles encompassed by a third-level sub-triangle have the same opacity value, only a single two-bit opacity value is stored in the lower-level data structure 1000 to represent all of the 16k tenth-level sub-triangles.

Where all 16k tenth-level sub-triangles encompassed by a third-level sub-triangle do not have the same opacity value, a two-bit value is stored in the lower-level data structure 1000 to indicate that not all of the 16k tenth-level sub-triangles have the same opacity value, and the 16k individual opacity values are stored separately in 64 higher-level data structures 1100 storing two-bit opacity values (or in 32 higher-level data structures 1100 storing one-bit opacity values).

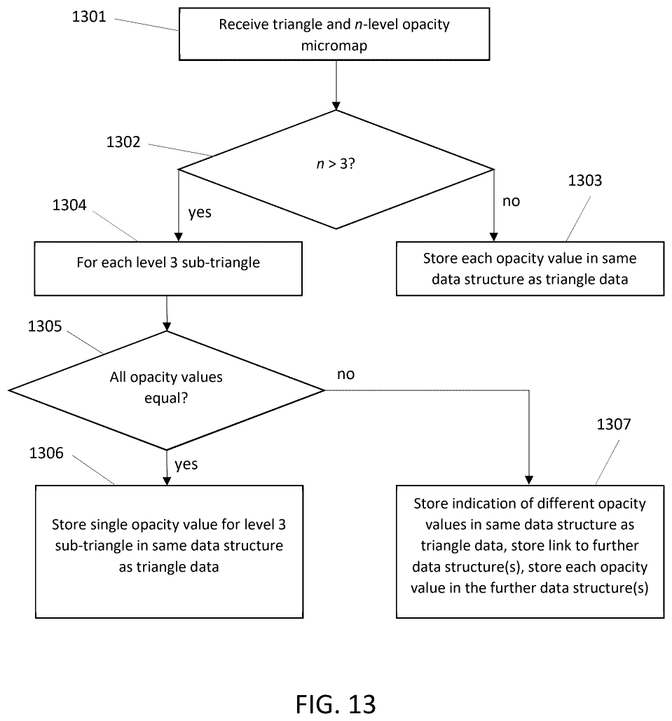

FIG. 13 shows a process for encoding and storing a micromap in accordance with embodiments. One or more micromaps may be defined by an application programmer, and e.g. provided to the graphics processor 2, 60 by driver 11 together with graphics commands. As shown in FIG. 13, when a triangle and associated micromap are received (at step 1301), it is determined (at step 1302) whether the level of the micromap is greater than a threshold level that corresponds to the highest micromap level that can be directly stored in a lower-level data structure 1000. In the present embodiments, as mentioned above, lower-level data structure 1000 can directly store up to a third-level (n=3) micromap, and the threshold level is thus three, but other threshold levels would be possible.

If the level of the micromap is not greater than the threshold level (e.g. three), each opacity value of the micromap is stored directly in the same, lower-level data structure 1000 as the triangle vertex data (at step 1303).

Otherwise, if the level of the micromap is greater than the threshold level (e.g. three), each threshold-level (e.g. third-level) sub-triangle of the micromap is taken in turn (at step 1304), and it is determined whether all of the opacity values encompassed by a threshold-level (e.g. third-level) sub-triangle are equal (at step 1305). If all of the opacity values encompassed by a threshold-level (e.g. third-level) sub-triangle are equal, only a single opacity value is stored in the same, lower-level data structure 1000 as the triangle vertex data (at step 1306).

Otherwise, if all of the opacity values encompassed by a threshold-level (e.g. third-level) sub-triangle are not equal, a single value indicating this is stored in the same, lower-level data structure 1000 as the triangle vertex data, together with a link to one or more higher-level data structures 1100 that store each individual opacity value encompassed by the threshold-level (e.g. third-level) sub-triangle of the micromap (at step 1307).

Thus, higher-level data structures 1100 are only generated and stored for those regions of a micromap that include different opacity values. This can reduce storage requirements and improve efficiency.

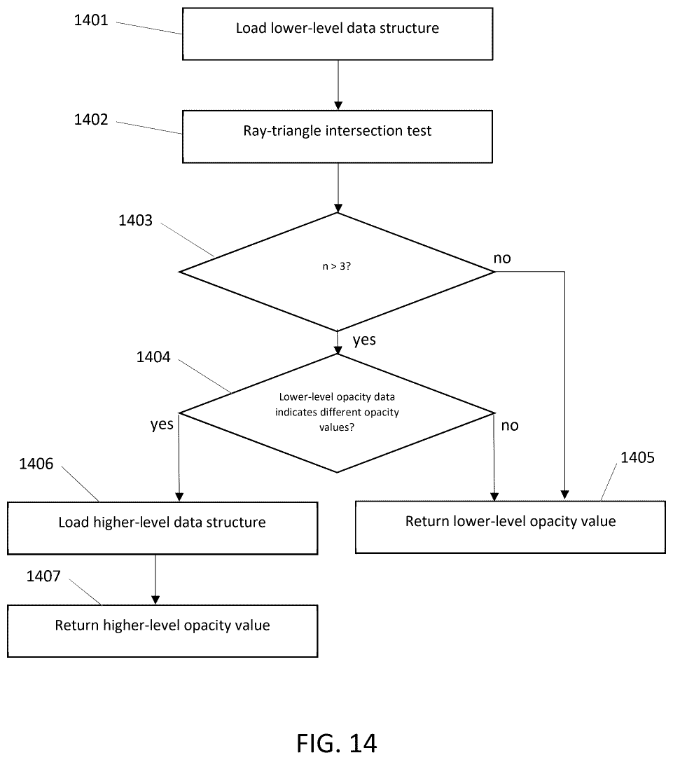

FIG. 14 shows a corresponding process for determining an opacity value for a triangle primitive intersection point 24 (e.g. corresponding to step 433 of FIG. 4B), in accordance with embodiments. As shown in FIG. 14, when a ray-triangle intersection test is to be performed, the lower-level data structure 1000 that stores the vertex data defining the triangle primitive 25 is loaded by load/store unit 76 (at step 1401), and the vertex data stored in the lower-level data structure 1000 is used by the ray data path unit 906 to perform a ray-triangle intersection test (at step 1402).

When a ray is found to intersect a triangle primitive 25, the intersection point 24 (in barycentric coordinates) and the corresponding micromap index may be determined, and used to locate the corresponding opacity data value stored in the lower-level data structure 1000. In the case of a third or lower-level opacity micromap (which will be stored directly in the lower-level data structure 1000), the corresponding opacity data value stored in the lower-level data structure 1000 is returned directly (at step 1405).

In the case of a fourth or higher-level opacity micromap (for which one or more further higher-level data structures 1100 may be stored), it is determined whether the corresponding opacity data value stored in the lower-level data structure 1000 indicates that the corresponding lower-level opacity values are different or not (at step 1404). This may comprise converting a higher-level micromap index to a lower-level index, and using the lower-level index to locate the corresponding data value stored in the lower-level data structure 1000, which in the present embodiment may comprise using some bits of the of the higher-level micromap index, e.g. using least significant bits (LSB) of the higher-level micromap index.

If the corresponding opacity data value stored in the lower-level data structure 1000 does not indicate that the corresponding lower-level opacity values are different (if the corresponding opacity data value stored in the lower-level data structure 1000 indicates that the corresponding lower-level opacity values are all the same), the corresponding opacity data value stored in the lower-level data structure 1000 is returned directly (at step 1405).

Otherwise, if the corresponding opacity data value stored in the lower-level data structure 1000 indicates that the corresponding lower-level opacity values are different, the base address data 1004 stored in the lower-level data structure 1000 is used to locate and load the appropriate higher-level data structure 1100 (at step 1406), and the corresponding opacity data value stored in the loaded higher-level data structure 1100 is returned (at step 1407).

In this way, lower-level opacity data values can act as a lower-level “filter”, such that higher-level data 1100 is only retrieved when necessary. This can reduce overall processing and bandwidth requirements.

Although in the above embodiments, there is in effect a single “filter” level (n=3), it would be possible to have multiple filter levels. For example, a lower-level data structure may store a lower-level representation of a micromap and one or more links to one or more intermediate-level data structures storing an intermediate-level representation of the micromap. The one or more intermediate-level data structures may store one or more links to one or more higher-level data structures storing a higher-level representation of the micromap, etc.

Although the above embodiments have been described with particular reference to efficiently handling micromaps for triangular primitives, it would be possible to handle other self-similar primitive shapes (such as rectangles, e.g. squares) in a corresponding manner.

Similarly, although the above embodiments have been described with particular reference to micromaps that store opacity values, values of other properties could be stored, such as scalars, colours, normals or other rendering properties.

The foregoing detailed description has been presented for the purposes of illustration and description. It is not intended to be exhaustive or to limit the technology to the precise form disclosed. Many modifications and variations are possible in the light of the above teaching. The described embodiments were chosen in order to best explain the principles of the technology and its practical application, to thereby enable others skilled in the art to best utilise the technology in various embodiments and with various modifications as are suited to the particular use contemplated. It is intended that the scope be defined by the claims appended hereto.

1. A method of operating a graphics processing system that is operable to render a scene represented by primitives by tracing rays through the scene and controlling interactions between rays and sub-regions of primitives using property values defined by one or more micromaps; the method comprising:
providing a micromap that defines property values for a set of sub-regions of a primitive;
generating and storing information representative of the micromap;
using the information to determine a property value defined by the micromap for a sub-region of the set of sub-regions of the primitive; and
using the determined property value to control an interaction between a ray and the sub-region of the primitive;
wherein:
the information comprises first information that can be used to determine whether further information should be used to determine a property value defined by the micromap; and
using the information to determine a property value defined by the micromap for a sub-region of the set of sub-regions of the primitive comprises:
using the first information to determine whether further information should be used to determine the property value for the sub-region; and
when it is determined that further information should be used to determine the property value for the sub-region:
fetching further information; and
using the further information to determine the property value for the sub-region.

2. The method of claim 1, wherein the first information represents a coarse representation of the micromap, and the further information represents a finer representation of the micromap.

3. The method of claim 1, wherein generating and storing the information representative of the micromap comprises:
determining whether a size of the micromap is greater than a threshold; and
when it is determined that a size of the micromap is greater than the threshold:
generating a coarse representation of the micromap; and
storing, as the first information, information representing the coarse representation of the micromap; and
when it is not determined that a size of the micromap is greater than the threshold:
storing, as the first information, information directly representing the micromap.

4. The method of claim 2, wherein generating a coarse representation of the micromap comprises, for one or more larger sub-regions of the primitive:
determining whether the micromap defines the same or different property values for sub-regions of the set of sub-regions that are encompassed by the respective larger sub-region; and
generating an indication of whether the micromap defines the same or different property values for sub-regions of the set of sub-regions that are encompassed by the respective larger sub-region.

5. The method of claim 4, further comprising:
when it is determined that the micromap defines different property values for sub-regions of the set of sub-regions that are encompassed by a larger sub-region:
generating and storing, as further information, information representing the different property values.

6. The method of claim 4, wherein using the first information to determine whether further information should be used to determine the property value for the sub-region comprises:
determining whether the coarse representation of the micromap indicates different property values for a larger sub-region that encompasses the sub-region; and
when it is determined that the coarse representation of the micromap indicates different property values for a larger sub-region that encompasses the sub-region:
determining that further information should be used to determine the property value for the sub-region.

7. The method of claim 3, wherein using the first information to determine whether further information should be used to determine the property value for the sub-region comprises:
determining whether the first information directly represents the micromap; and
when it is determined that the first information directly represents the micromap:
determining that further information should not be used to determine the property value for the sub-region.

8. The method of claim 3, comprising storing the first information in a first predefined data structure, wherein the threshold corresponds to a maximum amount of data that can be stored in the first predefined data structure.

9. The method of claim 1, comprising storing the first information together with data defining the primitive in a first predefined data structure.

10. The method of claim 1, comprising:
storing the first information in a first predefined data structure;
storing further information in one or more second predefined data structures; and
storing, in the first predefined data structure, one or more links to the one or more second predefined data structures.

11. A method of storing information representative of a micromap for use by a graphics processor that is operable to render a scene represented by primitives by tracing rays through the scene and controlling interactions between rays and sub-regions of primitives using property values defined by one or more micromaps; the method comprising:
providing a micromap that defines property values for a set of sub-regions of a primitive; and
generating and storing information representative of the micromap by:
for one or more larger sub-regions of the primitive:
determining whether the micromap defines the same or different property values for sub-regions of the set of sub-regions that are encompassed by the respective larger sub-region; and
generating and storing first information indicating whether the micromap defines the same or different property values for sub-regions of the set of sub-regions that are encompassed by the respective larger sub-region; and
when it is determined that the micromap defines different property values for sub-regions of the set of sub-regions that are encompassed by the respective larger sub-region:
generating and storing further information representing the different property values.

12. A non-transitory computer readable storage medium storing software code which when executing on a processor performs the method of claim 11.

13. A graphics processing system that is operable to render a scene represented by primitives by tracing rays through the scene and controlling interactions between rays and sub-regions of primitives using property values defined by one or more micromaps; the system comprising:
a generating circuit configured to generate and store information representative of a micromap, wherein the micromap defines property values for a set of sub-regions of a primitive; and
a processing circuit configured to:
use information generated and stored by the generating circuit to determine a property value defined by a micromap for a sub-region of a set of sub-regions of a primitive; and
use the determined property value to control an interaction between a ray and the sub-region of the primitive;
wherein:
the generating circuit is configured to generate and store information representative of a micromap that comprises first information that can be used by the processing circuit to determine whether further information should be used to determine a property value defined by the micromap; and
the processing circuit is configured to use information generated and stored by the generating circuit to determine a property value defined by a micromap for a sub-region of a set of sub-regions of a primitive by:
using first information to determine whether further information should be used to determine the property value for the sub-region; and
when it is determined that further information should be used to determine the property value for the sub-region:
fetching further information; and
using the further information to determine the property value for the sub-region.

14. The system of claim 13, wherein the first information represents a coarse representation of the micromap, and the further information represents a finer representation of the micromap.

15. The system of claim 13, wherein the generating circuit is configured to generate and store information representative of a micromap by:
determining whether a size of the micromap is greater than a threshold; and
when it is determined that a size of the micromap is greater than the threshold:
generating a coarse representation of the micromap; and
storing, as first information, information representing the coarse representation of the micromap; and
when it is not determined that a size of the micromap is greater than the threshold:
storing, as first information, information directly representing the micromap.

16. The system of claim 14, wherein the generating circuit is configured to generate a coarse representation of a micromap by, for one or more larger sub-regions of a primitive:
determining whether the micromap defines the same or different property values for sub-regions of the set of sub-regions that are encompassed by the respective larger sub-region; and
generating an indication of whether the micromap defines the same or different property values for sub-regions of the set of sub-regions that are encompassed by the respective larger sub-region.

17. The system of claim 16, wherein the generating circuit is configured to:
when it is determined that the micromap defines different property values for sub-regions of the set of sub-regions that are encompassed by a larger sub-region:
store, as further information, information representing the different property values;
or
wherein the processing circuit is configured to use first information to determine whether further information should be used to determine a property value for a sub-region by:
determining whether a coarse representation of the micromap indicates different property values for a larger sub-region that encompasses the sub-region; and
when it is determined that the coarse representation of the micromap indicates different property values for a larger sub-region that encompasses the sub-region:
determining that further information should be used to determine the property value for the sub-region.

18. The system of claim 15, wherein the processing circuit is configured to use first information to determine whether further information should be used to determine a property value for a sub-region by:
determining whether the first information directly represents the micromap; and
when it is determined that the first information directly represents the micromap:
determining that further information should not be used to determine the property value for the sub-region;
or
wherein the generating circuit is configured to store first information in a first predefined data structure, wherein the threshold corresponds to a maximum amount of data that can be stored in the first predefined data structure.

19. The system of claim 13, wherein the generating circuit is configured to store first information together with data defining a primitive in a first predefined data structure;
or
wherein the generating circuit is configured to:
store first information in a first predefined data structure;
store further information in one or more second predefined data structures; and
store, in the first predefined data structure, one or more links to the one or more second predefined data structures.

20. A graphics processor that is operable to render a scene represented by primitives by tracing rays through the scene and controlling interactions between rays and sub-regions of primitives using property values defined by one or more micromaps; the processor comprising:
a fetching circuit configured to fetch information representative of a micromap, wherein the micromap defines property values for a set of sub-regions of a primitive; and
a processing circuit configured to:
use information fetched by the fetching circuit to determine a property value defined by a micromap for a sub-region of a set of sub-regions of a primitive; and
use the determined property value to control an interaction between a ray and the sub-region of the primitive;
wherein the processing circuit is configured to use information fetched by the fetching circuit to determine a property value defined by a micromap for a sub-region of a set of sub-regions of a primitive by:
using first information to determine whether further information should be used to determine the property value for the sub-region; and
when it is determined that further information should be used to determine the property value for the sub-region:
causing the fetching circuit to fetch further information; and
using the further information to determine the property value for the sub-region.
